(19) United States
(12) Patent Application Publication
(10) Pub. No.: US 2006/0164954 A1
(43) Pub. Date: Jul. 27, 2006

(54) Optical pickup apparatus

(75) Inventor: Junji Hashimura, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/332,152

(22) Filed: Jan. 17, 2006

(30) Foreign Application Priority Data
Jan. 20, 2005 (JP) JP2005-013308

(51) Int. Cl. G11B 7/00

(52) U.S. Cl. 369/112.01; 369/44.37; 369/112.23

(57) ABSTRACT

In an optical pickup apparatus for reproducing and/or recording information from/onto four kinds of optical information recording mediums, an optical path of a light flux entering to a first objective optical element when using the first objective optical element and an optical path of a light flux entering to a second objective optical element when using a second objective optical element are arranged to be different so that a position of an incident light flux entering into the first objective optical element when using the first objective lens and a position of an incident light flux entering into the second objective optical element when using the second objective optical element are different in an orthogonal direction to an optical axis.

This application is based on Japanese Patent Application No. 2005-013308 filed on Jan. 20, 2005, in Japanese Patent Office, the entire content of which is hereby incorporated by reference.

### BACKGROUND OF THE INVENTION

The present invention relates to an optical pickup apparatus capable of compatibly recording and or reproducing information onto or from different kinds of optical information media.

### SUMMARY OF THE INVENTION

In recent years, shorter wavelength laser sources used as optical sources used for reproducing and/or recording information from/onto an optical disc have been developed. For example, blue violet semiconductor laser diodes, SHG lasers which convert the wavelength of infrared semiconductor laser by utilizing the second higher harmonic waves and laser sources having wavelengths of from 400 nm to 420 nm have been developed. For example, in the case of HD DVD which will be called HD from now on, it becomes possible to record information of 15 GB-20 GB onto an optical disc having diameter of 12 cm, when employing these blue violet laser sources together with an objective lens having the same numerical aperture (NA) used for DVD (Digital Versatile Disc). In the case of Blue-Ray Disc which will be called BD from now on, it becomes possible to record 23 GB -25 GB information onto an optical disc having diameter of 12 cm, when raising NA of an objective lens to 0.85. An optical disc employing a blue violet laser source and an optical magnetic disc will be generically named “a high-density optical disc” in this specification.

It is not good enough for the value of a product as an optical disc player or a recorder just having capability of appropriately recording and/or reproducing (hereinafter, merely referred as recording/reproducing) information onto or from a single high-density optical disc. It is required to appropriately record and/or reproduce information onto or from different kinds of high-density optical discs. Further, it is not good enough for the value of a product as an optical disc player or a recorder to have only capability of recording and or reproducing information on to a high-density optical disc based on the fact that currently DVDs and CDs (Compact Discs) on which many kinds of information are recorded are sold. It is required to have capability of appropriately recording and or reproducing information onto or from user's DVDs and CDs in order to increase the product value of an optical disc player/recorder for high-density optical discs. From these backgrounds described above, it is required for an optical pickup apparatus installed into an optical disc player/recorder for high density optical discs to have performance of appropriately recording and or reproducing information onto or from not only high-density optical discs and DVD but also CD while maintaining compatibility against any kind of discs.

An optical pickup apparatus having capability of recording and or reproducing information onto or from four different kinds of optical discs, BD (Blue-ray disk), HD (HD DVD), DVD and CD is disclosed in patent references, Japanese Patent Applications Open to Public No. JP2004-295983 and JP2004-319062.

However; with regard to the optical pickup apparatus disclosed in JP2004-295983, an objective lens for AOD (corresponding to HD), DVD and CD, and an objective lens dedicated for BD are independently provided. Further, a half mirror is arranged to reflect laser beams emitted from laser for BD/AOD when using AOD and to incident into the objective lens when using BD with 50% of total amount of laser beams. *In the case of a half mirror configuration, as described above, it is required to have equal to or more than two times of the amount of laser beams being originally necessary to record and/or reproduce information onto or from BD and HD. As a result, it is apparent that the cost of the optical pickup apparatus comes up. Further, there is anther problem that the weight of optical pickup apparatus increases since a double layer structure in which the light beam source and the optical system for DVD/CD and those for BD/AD are put together has to be used.

In JP2004-319062, two objectives lenses are employed as described above to realize compatibility between BD, HD, DVD and CD together with a configuration capable of switching the two objective lenses in responding to an optical disc onto or from which information is recorded and/or reproduced. According to this configuration,.there is possibility that the size of the optical pickup apparatus becomes large and the cost of the optical pickup apparatus becomes up, since it is necessary to have a highly precise switching mechanism to switch the objective lenses, even though there is a merit that laser beams from a laser beams source can be effectively utilized.

### BRIEF DESCRIPTION OF THE INVENTION

An object of the present invention is to provided an optical pickup apparatus having capability of compatibly recording and or reproducing information onto or from four different kinds of optical information media, while maintaining a low cost and compact size configuration to solve the problems associated with prior art described above.

The above object can be attained by the following structure.

An optical pickup apparatus for reproducing and/or recording information from/onto a first optical information recording medium including a protective layer having a thickness of t1 by using a light flux having wavelength of λ1, for reproducing and/or recording information from/onto a second optical information recording medium including a protective layer having a thickness of t2 (t2>t1) by using a light flux having wavelength of λ1, and for reproducing and/or recording information from/onto at least one of a third optical information recording medium including a protective layer having a thickness of t3 (t3=t2) by using a light flux having wavelength of λ2 and a fourth optical information recording medium including a protective layer having a thickness of t4 (t4>t3) by using a light flux having wavelength of λ3 (λ3>λ2), the optical pickup apparatus comprises:

a first light source for emitting a light flux having wavelength of λ1;

at least one of a second light source for emitting light flux having wavelength of λ2 and a third light source for emitting light flux having wavelength of λ3; and

a light converging optical system including a first objective optical element for forming a converged light spot when reproducing and/or recording information from or onto at least the first optical information recording medium and the second optical information recording medium, and

a second objective optical element for forming a converged light spot when reproducing and or recording information from or onto at least one of the third optical information recording medium and the fourth optical information recording medium,

wherein an optical path of a light flux entering to the first objective optical element when using the first objective optical element and an optical path of a light flux entering to the second objective optical element when using the second objective optical element are arranged to be different so that a position of an incident light flux entering into the first objective optical element when using the first objective lens and a position of an incident light flux entering into the second objective optical element when using the second objective optical element are different in an orthogonal direction to an optical axis.

### BRIEF DESCRIPTION OF THE DRAWINGS

FIG. 1 illustrates a drawing for explaining the present invention.

FIG. 2 illustrates a drawing for explaining the present invention.

FIG. 3 illustrates a drawing for explaining the present invention.

FIG. 4 illustrates a schematic cross sectional view of an optical pickup apparatus capable of compatibly recording and or reproducing information onto or from all discs, BD, HD, DVD and CD.

FIG. 5 illustrates a cross sectional view of a lens holder holding two object lenses which will be also named an objective optical element.

FIG. 6 illustrates a perspective view of an optical unit CU having an expander lens EXP including lenses L1-L2 integrally installing a driving device, which can be utilized in an optical pickup apparatus shown in FIG. 4.

FIG. 7 illustrates a perspective view of a layered piezoelectric actuator PZ having a structure in which a plurality of piezoelectric ceramics PE has been piled up and electrodes C placed between the piezoelectric ceramics are connected in parallel.

FIG. 8 illustrates the waveforms of voltage pulses being applied onto piezoelectric actuator PZ.

FIG. 9 illustrates a schematic cross sectional view of an optical pickup apparatus capable of compatibly recording and or reproducing information onto or from all discs, BD, HD, DVD and CD.

FIG. 10 illustrates a schematic cross sectional view of an optical pickup apparatus capable of compatibly recording and or reproducing information onto or from all discs, BD, HD, DVD and CD.

FIG. 11 illustrates a schematic cross sectional view of another optical system capable of compatibly recording and or reproducing information onto or from discs of BD and HD.

FIG. 12 illustrates a schematic cross sectional view of still another optical system capable of compatibly recording and or reproducing information onto or from discs of BD and HD.

### DETAILED DESCRIPTION OF THE PREFERRED EMBODIMENT

Firstly, a preferable embodiment of the present invention to realize an object of the present invention will be explained.

1. An optical pickup apparatus for reproducing and/or recording information from/onto a first optical information recording medium including a protective layer having a thickness of ti by using a light flux having wavelength of λ1, a second optical information recording medium including a protective layer having a thickness of t2 (t2>t1) by using a light flux having wavelength of λ1, a third optical information recording medium including a protective layer having a thickness of t3 (t3=t2) by using a light flux having wavelength of λ2 and a fourth optical information recording medium including a protective layer having a thickness of t4 (t4>t3) by using a light flux having wavelength of λ3 (λ3>λ2), the optical pickup apparatus comprises a first light source for emitting light flux having wavelength of λ1, a second light source for emitting light flux having wavelength of λ2, a third light source for emitting light flux having wavelength of λ3 and a light converging optical system including a first objective optical element for forming a converged light spot at least onto the first and the second optical information recording media when reproducing and or recording information from or onto at least the first optical information recording medium and the second optical information recording medium, and a second objective optical element for forming a converged light spot at least onto the fourth optical information recording medium when reproducing and or recording information from or onto at least the fourth optical information recording medium, wherein a light beam path which is formed by light flux entering to the first objective optical element when using the first objective optical element and a light beam path formed by light flux entering to the second objective optical element when using the second objective optical element are arranged to be different so that a position of incident light flux entering into the first objective optical element when using the first objective lens, and a position of incident light flux entering into the second objective optical element when using the second objective optical element are different in an orthogonal direction against an optical axis.

According to the present invention, it becomes possible to efficiently utilize light flux emitted from the first light source since a light beam splitting device such as a half mirror becomes unnecessary, which is needed when providing different objective optical elements to focus light flux onto each surface of the first optical information recording medium and the second optical information medium, since the first objective optical element focuses the light flux having wavelength λ1 being the shortest wavelength onto the information recording surfaces of different kinds of recording media which are the first optical recording medium and the second optical recording medium. Further, in the present invention, the first objective optical element and the second objective optical element are not switched to locate themselves into a common optical path and a supporting member of the first objective optical element and the second objective optical element is substantially kept in a fixed location as a whole against the optical pickup apparatus when the medium is changed. When using the first objective optical element, at least an optical path for guiding the light flux to the first objective optical element is formed and when using the second objective optical element, at least an optical path to guide the light flux to the second objective optical element is formed. Consequently, it becomes possible to make an optical pickup apparatus simple and compact with lower cost since a highly precise switching mechanism to switch the first objective optical element and the second objective optical element can be eliminated.

For example, assuming that the first optical information recording medium is BD, the second optical information recording medium is HD, the third optical information recording medium is DVD and the fourth optical information recording medium is CD, it is possible to use blue violet laser as the first light source, red colored laser as the second light source and infrared laser as the third light source. By applying the present invention, it becomes possible to realize compatibility regardless of the differences of wavelength, numerical aperture (numerical aperture difference) or protective layer thinness of an optical information recording medium.

2. The optical pickup apparatus of item 1, wherein the first objective optical element is used for forming a converged light spot when reproducing and or recording information from or onto the third optical information recording medium.

3. The optical pickup apparatus of item 1, wherein the second objective optical element is used for forming a converged light spot when reproducing and or recording information from or onto the third optical information recording medium.

4. The optical pickup apparatus as in any one of items 1-3, wherein the first objective optical element and the second objective optical element are placed in a radius direction of an optical information recording medium from or onto which information is reproduced and or recorded, when viewing from an optical axis direction.

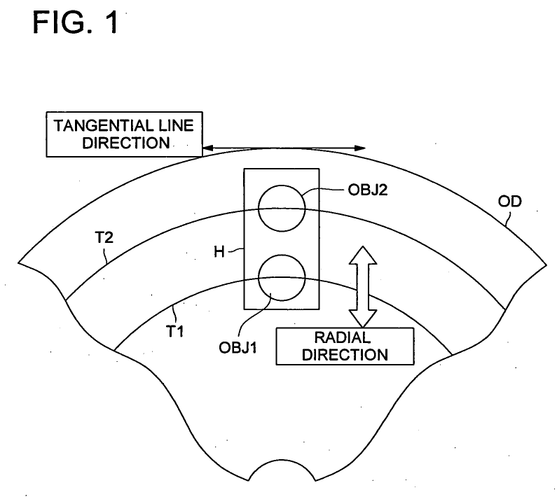

FIG. 1 illustrates a drawing to explain the present invention. In FIG. 1, a supporting member H supports the first objective optical element OBJ1 and the second objective optical element OBJ2. The supporting member H is arranged so that a coarse actuator (not shown) moves the supporting member H in a radial direction against an optical information recording medium from or onto which information is reproduced and or recorded. The supporting member H is also arranged so that a two-axis actuator (not shown) controls the supporting member H to move in a focusing direction and a tracking direction. Since the first objective optical element OBJ1 and the second objective optical element OBJ2 are arranged in the radius direction of an optical information recording medium OD, a track T1 onto which a converged light spot is formed by the first objective optical element OBJ1 is located far away from a track T2 onto which a converged light spot is formed by the second objective optical element is formed. However, since each objective optical element is arranged to move along with the radius direction of the optical information recording medium OD, it is suitable to focus the light flux having wavelengths λ1 and λ2.

5. The optical pickup apparatus as in any one of items 1-3, wherein the first objective optical element and the second objective optical element are placed parallel to a tangential line direction of an optical information recording medium from or onto which information is reproduced and or recorded, when viewing from an optical axis direction.

6. The optical pickup apparatus of item 5, wherein a line connected between optical axes of the first objective optical element and the second objective optical element is orthogonal to a line extending in a radius direction of an optical information recording medium from or onto which information is reproduced and or recorded on an optical axis of the first objective optical element or an optical axis of the second objective optical element, when viewing from an optical axis direction.

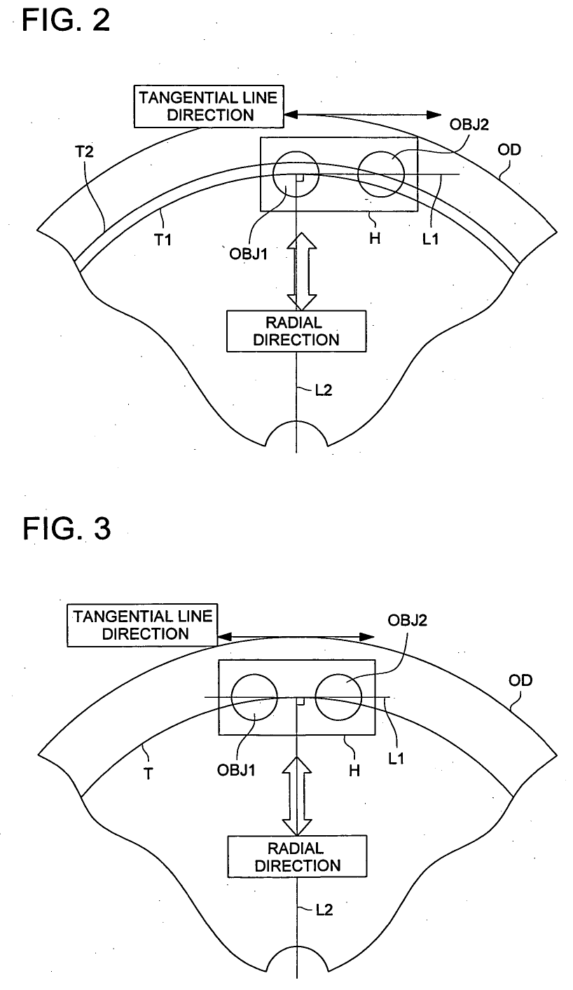

FIG. 2 illustrates a drawing to explain the present invention. In FIG. 2, a supporting member H supports the first objective optical element OBJ1 and the second objective optical element OBJ2. The supporting member H is arranged so that a coarse actuator (not shown) moves the supporting member H in a radial direction against an optical information recording medium from or onto which information is reproduced and or recorded. The supporting member H is also arranged so that a two-axis actuator (not shown) controls the supporting member H to move in a focusing direction and a tracking direction. Since the first objective optical element OBJ1 and the second objective optical element OBJ2 are arranged parallel to the tangential line direction of the optical information recording medium OD, and a line L1 drawn between the first objective optical element OBJ1 and the second objective optical element. OBJ2 is arranged to be orthogonal to line L2 extended in the radius direction of the optical information recording medium OD, track T1 on which a converged light spot is formed by the first objective optical element OBJ1 is slightly away from track T2 on which a converged light spot is formed by the second objective optical element OBJ2. Since the first objective optical element OBJ1 is arranged to move along the radius direction of the optical information recording medium OD, it is suitable to focus light flux having wavelength λ1.

7. The optical pickup apparatus of item 5, wherein a line connected between optical axes of the first objective optical element and the second objective optical element is arranged to orthogonal to a line extended in a radius direction of an optical information recording medium from or onto which information is reproduced and or recorded, in an area other than optical axes of the first objective optical element and the second objective optical element, when viewing from an optical axis direction.

FIG. 3 illustrates a drawing to explain the present invention. In FIG. 3, a supporting member H supports the first objective optical element OBJ1 and the second objective optical element OBJ2. The supporting member H is arranged so that a coarse actuator (not shown) moves the supporting member H in a radial direction against an optical information recording medium OD from or onto which information is reproduced and or recorded. The supporting member H is also arranged so that a two-axis actuator (not shown) controls the supporting member H to move in a focusing direction and a tracking direction. Since the first objective optical element OBJ1 and the second objective optical element OBJ2 are arranged in the direction parallel,to the tangential direction of an optical information recording medium OD, and the line L1 connected between the optical axes of the first objective optical element OBJ1 and the second objective optical element OBJ2 is orthogonal to the line L2 extended to the radial direction of optical information recording medium OD at the center between the optical axis of the first objective optical element OBJ1 and the optical axis of the second objective optical element OBJ2, a track T on which the converged light spot formed by the first objective optical element OBJ1 is substantially the same as the track T on which the converged light spot formed by the second objective optical element OBJ2. It becomes possible to provide a compact configuration of an optical pickup apparatus since the projection of the supporting member H can be made small.

8. The optical pickup apparatus of item 5, wherein a line connected between optical axes of the first objective optical element and the second objective optical element is arranged to non-orthogonal to a line extended in a radius direction of an optical information recording medium from or onto which information is reproduced and or recorded, in an area other than optical axes of the first objective optical element and the second objective optical element, when viewing from an optical axis direction. Taking FIG. 3 as an example, this is the case when the line L1 is non-orthogonal to the line L2.

9. The optical pickup apparatus as in any one of items 1-8, wherein at least either the first objective optical element or the second objective optical element is configured by a single element.

10. The optical pickup apparatus of item 9, wherein the single element is made from glass.

11. The optical pickup apparatus of item 9, wherein the single element is made from plastic.

12. The optical pickup apparatus as in anyone of items 1-8, wherein at least either the first objective optical element or the second objective optical element is configured by a plurality of elements.

13. The optical pickup apparatus of item 12, wherein the plurality of elements is make from glass.

14. The optical pickup apparatus of item 12, wherein the plurality of elements is make from plastic.

15. The optical pickup apparatus of item 12, wherein at least one element in the plurality of elements is made from glass and rest of the elements in the plurality of elements are make from plastic.

16. The optical pickup apparatus as in any one of items 1-15, wherein at least an optical surface of either the first objective optical element or the second objective optical element includes a diffraction structure or a phase difference generation structure. Here, “a, phase structure” is a structure which generates diffracted light flux of predetermined order corresponding to transmitting light flux. “A phase difference generation structure” is a structure which generates predetermined phase differences corresponding to transmitting light flux.

17. The optical pickup apparatus as in any one of items 1-16, wherein the light converging optical system comprises a correction element for correcting spherical aberration caused by a difference between a thickness of a protective layer of the first optical information recording medium and a thickness of a protective layer of the second optical information recording medium.

18. The optical pickup apparatus of item 17, wherein the correction element is arranged to move in an optical axis direction.

19. The optical pickup apparatus of item 18, further comprises a driving device for moving the correction element in the optical axis direction, the driving device including an electro-mechanical conversion element, a driving member fixed onto one end of the electro-mechanical conversion element, a moving member connected to the correction element supported on the driving member so that the correction element freely moves and a driving circuit for inputting voltage to the electro-mechanical conversion element, wherein the moving member is relatively moved against the driving member by extension and contraction of the electro-mechanical conversion element, the extension and contraction being generated corresponding to inputted voltage from the driving circuit.

The electro-mechanical conversion element as the driving device can be deformed by applying driving voltage, such as pulse having saw-tooth pattern waveform to the electro-mechanical conversion element in a short period of time so that the electro-mechanical conversion element slightly extends and contracts. The rate of the extension and contraction of the electro-mechanical conversion element can be changed by changing the pulse waveform. However, when deforming the electro-mechanical conversion element in a extension direction or a contraction direction at high rate, due to the inertia of mass of the moving member, the moving member can not follow the rate and it remain the same position. On the other hand, when deforming the electro-mechanical conversion element in a different direction at lower rate, the moving member moves following to the movement of the driving member due to the friction force acting while the driving voltage is applied. Accordingly, it is possible to continuously move the moving member in one direction by repeating the extension and contraction of the electro-mechanical conversion element. Namely, it is possible to move the correction element connected to the moving member at a high rate and also to slightly move the correction element with quick response by utilizing the driving device being related to the present invention. Further, when holding the moving member at a constant position, it is possible to hold the moving member at a constant position by the friction force generated between the moving member and the driving member by stopping power supplied to the electro-mechanical conversion element. Accordingly, energy can be saved. Additionally, it is possible to make the configuration of the driving device simple and small with lower cost. Consequently, with regard to an optical pickup apparatus, it is possible to precisely correct comma aberration with a high rate, for example, by driving the correction element arranged between the light source and the objective optical element in a direction crossing to the optical axis, and to realize a compact optical pickup apparatus having lower power consumption with relatively lower cost.

20. The optical pickup apparatus of item 18, further comprising a stepping motor for moving the correction element in an optical axis direction.

21. The optical pickup apparatus as in any one of items 1-17, wherein the first objective optical element comprises a diffraction structure for generating diffracted light flux having different plural orders at least against light flux having a wavelength of λ1 corresponding to an optical information recording medium from or onto which information is reproduced and or recorded.

22. The optical pickup apparatus of item 21, wherein the diffracted light flux having the different plural orders includes either (n+1) order diffracted light flux or (n−1) order diffracted light flux when one of light beam has n order diffracted light flux, wherein “n” denotes an integer.

23. The optical pickup apparatus of item 21, wherein the diffraction structure is placed within an area corresponding to an numerical aperture being equal to or less than an image-side numerical aperture of the objective optical element needed for reproducing and or recording information from or onto the second optical information recording medium by using the first light source.

According to the present invention described in items 22 and 23, when using an optical configuration capable of focusing a single wavelength light flux onto the first optical information recording medium and the second optical information recoding medium, it is possible to correct spherical aberration caused by the difference of protective layers by optimizing the diffraction efficiency for each recording medium. Particularly, in item 23, it is possible to optimize the efficiency of light flux focused onto both media, by adjusting the efficiency of light flux focused onto the first optical information recording medium to 100% in a first area through which only light flux focused onto the first optical recording medium pass, while optimizing the light beam efficiency in a second area through which light flux focused onto both the first optical information recording medium and the second optical information recording medium. Additionally, it is also possible to correct spherical aberration caused by the difference between the wavelengths of light flux passing through the diffraction structure.

24. The optical pickup apparatus of item 17, wherein the correction element is a liquid crystal element.

25. The optical pickup apparatus as in any one of items 1-24, wherein the first light source and the second light source are configured into a same light source unit.

26. The optical pickup apparatus as in any one of items 1-24, wherein the second light source and the third light source are configured into a same light source unit.

27. The optical pickup apparatus as in any one of items 1-24, wherein the first light source and the third light source are configured into a same light source unit.

28. The optical pickup apparatus as in any one of items 1-27, wherein the light converging optical system includes a dichroic prism. Accordingly, it is possible to provide a simple optical pickup apparatus which does not drive optical elements other than an objective optical element therein.

29. The optical pickup apparatus as in any one of items 1-27, wherein the light converging optical system includes either a mirror or a prism. Accordingly, it is possible to provide a simple optical pickup apparatus which does not drive optical elements other than an objective optical element therein.

30. The optical pickup apparatus as in any one of items 1-29, wherein the first light source has light flux having wavelength λ1 being not less than 380 nm and not more than 450 nm, the second light source has light flux having wavelength λ2 being not less than 600 nm and not more than 700 nm and the third light source has light flux having wavelength λ3 being not less than 700 nm and not more than 800 nm. Still, it is not necessary to use the same light flux having the same wavelength to reproduce and or record information from or onto the first optical information recording medium and the second optical information recording medium when wavelength λ1 falls within the rage described above. Light flux having the same wavelength may be used to reproduce and or record information from or onto the third optical information recording medium and the fourth optical information recording medium.

31. The optical pickup apparatus as in any one of items 1-31, wherein the first optical information recording medium has a protective layer having a thickness of t1 being within 0.1×0.03 mm, the second and the third optical information recording media respectively has a protective layer having thickness of t2 or t3 being within 0.6±0.1 mm and the fourth optical information recording medium has a protective layer having a thickness of ti being within 1.2±0.1 mm.

32. The optical pickup apparatus as in any one of items 1-31, wherein an objective optical element used to reproduce and or record information from or onto the first optical information recording medium has a numerical aperture NA1 falling within the range of 0.8-0.9, an objective optical element used to reproduce and or record information from or onto the second optical information recording medium has numerical aperture NA2 falling within the range of 0.6-0.7, an objective optical element applied to reproduce and or record information from or onto the third optical information recording medium has numerical aperture NA3 falling within the range of 0.58-0.68 and an objective optical element applied to reproduce and or record information from or onto the fourth optical information recording medium has numerical aperture NA4 falling within the range of 0.45-0.55.

According to the present invention, it is possible to provide an optical pickup apparatus capable of compatibly reproducing and or recording information from or onto four kinds of different optical information recording media while maintaining the optical pickup apparatus in compact size and lower cost.

In this specification, an optical disc, or an optical information recording medium, may also include the optical disc including an protective film having thickness of from several nm to several tens nm on an information recording surface and an optical disc including a protective layer or a protective film having thickness being zero, other than the optical disc having a protective layer or protective substrate. Also, in this specification, a high density optical disc may include a magnet-optical disk onto or from which information is recorded and or reproduced by using blue violet semiconductor laser and blue violet SHG laser as a light source. Further, the relationship between the recording capacity of the first optical information recording medium τ1, the recording capacity of the second optical information recording medium τ2, the recording capacity of the third optical information recording medium τ3 and the recording capacity of the forth optical information recording medium 4τ satisfies τ1>τ2>τ3>τ4.

Further, in the present specification, the “objective optical element” indicates an optical system which, in the optical pick-up apparatus, is arranged at the position opposite to the optical disk, and has a function to light converge the light flux projected from the light source on the information recording surface of the optical disk, and can be moved at least in the optical axis direction by the actuator. The “objective lens” in the present specification may also be a single lens, or may also be composed of a plurality of lenses. The objective lens is not included in a relay lens group in the present specification. Incidentally, “objective optical element” is the same meaning of “objective lens”.

Further, in the present specification, the numerical aperture NA of the optical information recording medium side (image side) of the objective lens indicates, when the objective lens has a plurality of lenses, the numerical aperture NA of the optical surface positioned on the most optical information recording medium side of the objective lens. Further, the numerical aperture (NA) or necessary numerical aperture in the present specification indicates the numerical aperture of the objective optical system of the diffraction limit performance by which the necessary spot diameter can be obtained for conducting the recording of the information or the reproducing operation corresponding to the wavelength of the light source to be used for the numerical aperture regulated by the regulation of respective optical information recording medium, or for the respective optical information recording medium.

In the lens group in the present specifications a case where it is composed of one single lens, is included. Accordingly, the movable lens group indicates a single lens when it is composed of a single lens which can be moved in the optical axis direction, and a plurality of lenses when it is composed of a plurality of lenses which can be integrally moved in the optical axis direction.

Further, in this specification, DVD is a generic name of a DVD optical disc family such as DVD-ROM, DVD-Video, DVD-Audio, DVD-RAM, DVD-R, DVD-RW and DVD+RW and CD is a generic name of a CD optical disc family such as CD-ROM, CD-Audio, CD-Video, CD-R and CD-RW. The recording density serves as order of a high density optical disc, a DVD and a CD.

An embodiment of the present invention will be explained in detail below by referring to drawings.

### First Embodiment

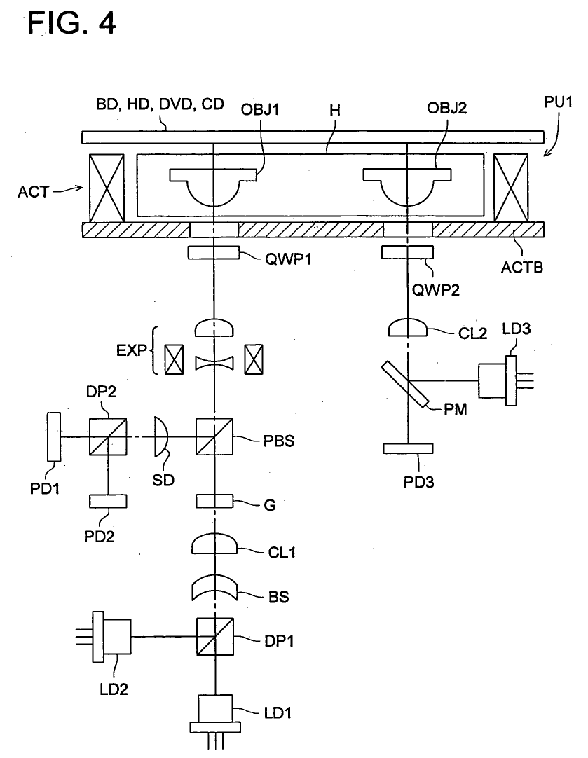

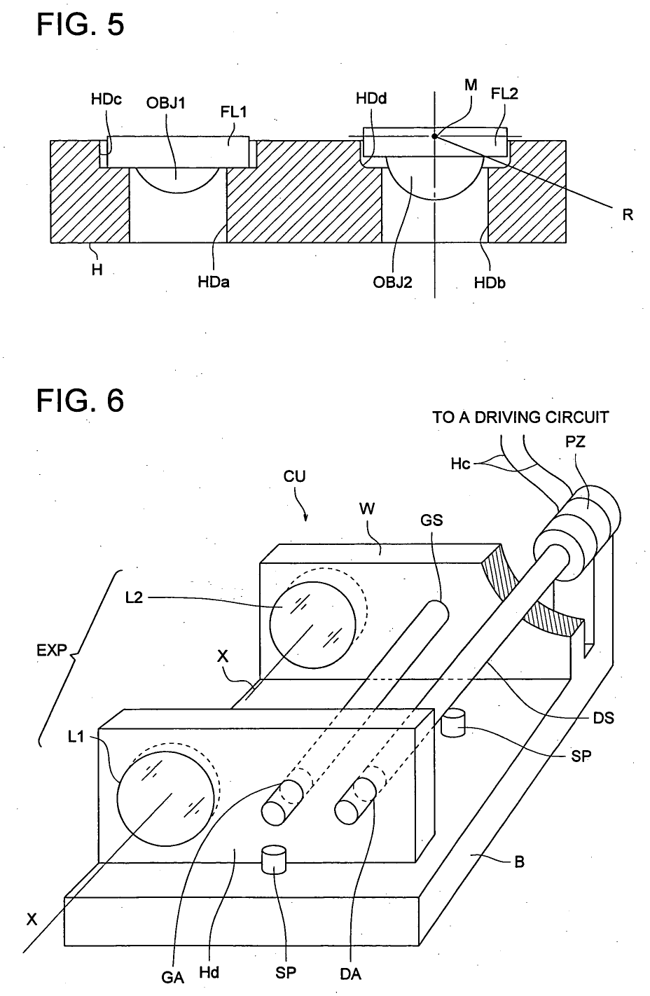

FIG. 4 illustrates a schematic sectional view of an optical pickup apparatus, according to the first embodiment, capable of compatibly recording and or reproducing information onto or from all types of optical information recording media such as BD (a first optical information recording medium), HD (a second optical information recording medium), DVD (a third optical information recording medium) and CD (a fourth optical information recording medium). FIG. 5 illustrates a sectional view of a lens holder holding two objective lenses which will be called an objective optical element.

In FIG. 5, a lens holder H has two openings HDa and HDb, each having axis line being substantially parallel to each other. A flange FL1 of the first objective lens. (the first objective optical element) OBJ1 is attached to a spot-facing HDc located at the upper face of the opening HDa so that the flange FL1 faces to the spot-facing HDc. On the other hand, the upper surface of the internal surface of the spot-facing HDd is formed into a spherical surface substantially centering on a principal point M of the second objective lens. (the second objective optical element) OBJ2. The second objective lens OBJ2 is attached to the lens holder H so that the internal surface faces to the flange LF2. In this embodiment of the present invention, the configuration of the lens holder H against the optical information recording medium may be as shown in FIG. 1, but not limited to. It may also be as shown in FIG. 2, 3 or other than this embodiment.

As shown in FIG. 4, the lens holder H is supported by an actuator ACT so that it moves at least in two-dimension. The actuator ACT has an actuator base ACTB so that the position of the actuator base ACT can be adjustable against an optical pickup frame (not show). Two openings are formed on the actuator base ACTB. One opening is arranged so that light flux incident into the first objective lens OBJ1 pass through the opening when recording and or reproducing information onto or from BD, HD or DVD, and another opening is arranged so that light flux incident into the second objective lens OBJ2 pass through the opening when recording and or reproducing information onto or from CD.

Firstly, the operation for recording and or reproducing information onto or from BD, will be explained. In FIG. 4, light flux emitted from a first semiconductor laser diode LD1 (wavelength λ1=380 nm-450 nm) are shaped into parallel light flux after passing through a dichroic prism DP1, a beam shaper BS which corrects the light flux and a first collimator lens CL1. The light flux outputted from the first collimator lens CL1 pass through a diffraction grating G for separating light flux emitted from a light source into main beams used to recording and reproducing information and the sub beams used for detecting tracking error signal, and further a polarization beam splitter PBS and an expander lens EXP. The expander lens EXP changes the light beam diameter of parallel light flux. In this case it expands the light beam diameter, and at least one of optical elements in the expander lens EXP is arranged to move in the optical axis direction.

Light flux passed through the expander lens EXP pass through a first quarter wave panel QWP1 and the first objective lens OBJ1 focuses the light flux and forms a converged light spot onto an information recording surface after passing through a protective layer (thickness t1=0.1 mm) of BD.

The light flux modulated by information pits on the information recording surface pass back through the objective lens OBJ1, the first quarter wave plate QWP1 and the expander lens EXP. Then the polarized beam splitter PBS reflects the light flux. The light flux pass through a sensor lens SL and a second dichroic prism DP2, and reach to a first photo detector PD1. Read out signal of information recorded on BD can be obtained by using the output signal of the first photo detector PD1.

Further, focal point detection and track detection will be conducted by detecting the change of the light beam amount resulting from the beam spot shape changes on the first photo detector PD1 and the change of the light beam amount resulting from the position change of the light beam spot on the first photo detector PD1. Based on these detections, the actuator ACT moves the first objective lens OBJ1 together with the lens holder H so that the light flux from the first semiconductor laser LD1 are focused on the information recording surface of BD.

Next, the operation for recording and or reproducing information onto or from HD, will be explained. In FIG. 4, light flux emitted from a first semiconductor laser diode LD1 (wavelength λ1=380 nm-450 nm) are shaped into parallel light flux after passing through a dichroic prism DP1, a beam shaper BS which corrects the shape of the light flux and a first collimator lens CL1. The light flux outputted from the first collimator lens CL1 pass through a diffraction grating G for separating light flux emitted from a light source into main beams used for recording and reproducing information and the sub beams used for detecting tracking error signal, a polarization beam splitter PBS and an expander lens EXP. A part of lens of an expander lens EXP being a correction element is moved in the optical axis direction by an actuator, which will be described later, to correct spherical aberration caused by the differences between the thicknesses of the protective substrates of BD and HD. A diaphragm (not shown) may be used to correspond the differences between the numerical apertures of BD and HS. The objective lens may also have an aperture-limiting function, for example, in an area between an effective diameter area corresponding to a numerical aperture when BD is used and an effective diameter area corresponding to a numerical aperture when HD is used so that the objective lens focuses light flux without aberration against a BD disc protective substrate, and the objective lens focuses light flux by generating aberration against a HD protective substrate when recording and or reproducing information onto or from the optical information recording surface of HD in order not to interfere the converged light spot by eliminating flare caused by unnecessary light flux. The aperture-limiting function can be realized by using a phase structure or by providing, at least, an aspherical surface having two areas, one in the inside of a HD numerical aperture area and another in the outside of the HD numerical aperture area.

Light flux passed through the expander lens EXP pass through a first quarter wave panel QWP1 and the first objective lens OBJ1 focuses the light flux and forms a converged light spot onto an information recording surface after passing through a protective layer (thickness ρ2=0.6 mm) of HD.

The light flux modulated by information pits on the information recording surface pass back through the objective lens OBJ1, the first quarter wave plate QWP1, the expander lens EXP and are reflected by the polarized beam splitter PBS. Then the light flux pass through a sensor lens SL and a second dichroic prism DP2 and reach to a first photo detector PD1. Read out signal of information recorded on HD can be obtained by using the output signal of the first photo detector PD1.

Also, focal point detection and track detection will be conducted by detecting the change of light beam amount caused by the beam spot shape changes and the position change of the light beam spot on the first photo detector PD1. Based on this detection, the actuator ACT moves the first objective lens OBJ1 together with the lens holder H so that the light flux from the first semiconductor laser LD1 are focused on the information recording surface of HD.

Next, the operation for recording and or reproducing information onto or from DVD will be explained. Light flux emitted from a second semiconductor laser diode LD2 (wavelength λ2=600 nm-700 nm) are shaped into parallel light flux after being reflected by a first dichroic prism DP1 and passing through a beam shaper BS which corrects the light flux and a first collimator lens CL1. The light flux outputted from the first collimator lens CL1 pass through a diffraction grating G, a polarization beam splitter PBS and an expander lens EXP.

Light flux passed through the expander lens EXP pass through a first quarter wave panel QWP1 and the first objective lens OBJ1 focuses the light flux and forms a converged light spot onto an information recording surface after passing through a protective layer (thickness t3=0.6 mm) of DVD.

The light flux modulated by information pits on the information recording surface pass back through the objective lens OBJ1, the first quarter wave plate QWP1 and the expander lens EXP, and are reflected by the polarized beam splitter PBS. Then the light flux pass through a sensor lens SL and are reflected by a second dichroic prism DP2. The light flux reach to a second photo detector PD2. The readout signal of information recorded on DVD can be obtained by using the output signal of the second photo detector PD2.

Also, focal point detection and track detection will be conducted by detecting the change of light beam amount resulting from the beam spot shape changes on the second photo detector PD2 and the change of light beam amount resulting from the position change of the light beam spot on the second photo detector PD2. Based on these detections, the actuator ACT moves the first objective lens OBJ1 together with the lens holder H so that the light flux from the second semiconductor laser LD2 are focused on the information recording surface of DVD.

Further, the operation for recording and or reproducing information onto or from CD, will be explained. Light flux emitted from a third semiconductor laser diode LB3 (wavelength λ3=700 nm-800 nm) are shaped into parallel light flux after being reflected by a polarized mirror PM and passing through a second collimator lens CL2. The light flux outputted from the second collimator lens CL2 are focused onto an information recording surface of CD by a second objective lens OBJ2 after passing through a second quarter wave plate QWP2 and a protective layer (thickness t4=1.2 mm) of CD.

The light flux modulated by information pits on the information recording surface pass back through the second objective lens OBJ2, the second quarter wave plate QWP2, the second collimator lens CL2 and the polarized mirror PM. Then the light flux reach to a third photo detector PD3. The readout signal of information recorded on CD can be obtained by using the output signal of the third photo detector PD3.

Also, focal point detection and track detection will be conducted by detecting the change of light beam amount caused by the beam spot shape changes and the position change of the light beam spot on the third photo detector PD3. Based on this detection, the actuator moves the second objective lens OBJ2 together with the lens holder H so that the light flux from the third semiconductor laser LD3 are focused on the information recording surface of CD.

FIG. 6 illustrates a perspective view of an optical unit CU which integrally installs a driving device together with an expander lens EXP having lenses L1 and L2, which can be utilized in an optical pickup apparatus shown in FIG. 4. In FIG. 6, a wall W is formed on the upper surface of a base B. A guide shaft GS provided in the wall W, (a part of which is cut off for illustration), extends along with base B. A lens L2 is fixed on the opening formed on the wall W.

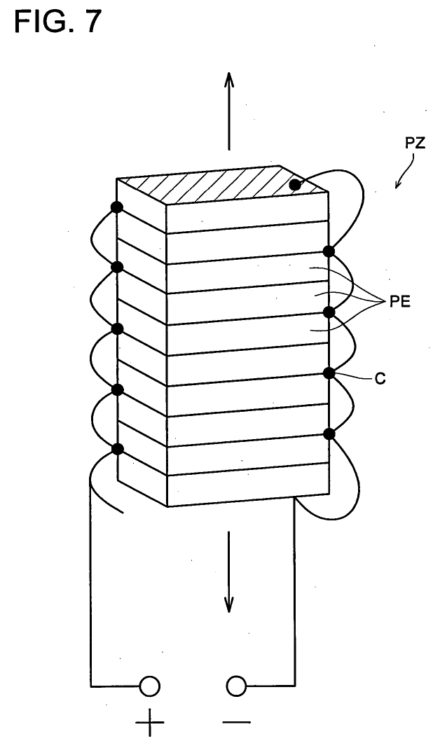

The rear end of a piezoelectric actuator being a electro-mechanical conversion element PZ is attached on the base B. The piezoelectric actuator PZ is made by the layered piezoelectric ceramics of by PZT (zircon, lead titanate). The piezoelectric ceramic has characteristic which will be extended when inputting voltage in a polarization direction since the center of gravities between a positive charge and a negative charge in a crystal lattice does not coincide. However, since the strain of a piezoelectric ceramic in this direction is little, and it is difficult to drive a driven member based on this strain, a layered type piezoelectric actuator PZ having layered plural piezoelectric ceramics PE having electrodes C therebetween as shown in FIG. 7 is utilized and available. In this embodiment, this type of piezoelectric actuator is used as a driving source.

A driving shaft DS being a driving member is attached at the front end of the piezoelectric actuator PZ. The driving shaft DS penetrated through the wall W is connected with a driving aperture DA of the lens holder Hd being a moving member with appropriate friction force.

The lens holder Hd having a lens L1 being an optical element placed in an opening provided therein is arranged to move along the guide shaft GS on the base B.

The control of the movement amount of a moving lens can be conducted by using the method for detecting a lens movement amount or the method for detecting aberration formed on an optical information recording surface by light flux from a light source passed through an objective lens.

Provided is an external driving circuit (not shown) for inputting voltage to the piezoelectric actuator PZ through electric cables Hc when receiving signals (positioning information) from an encoder (being a positioning information obtaining device, for example, having magnetic information placed on the guide shaft GS and providing a read-head on the lens holder Hd) magnetically or optically detecting the movement amount of the lens holder Hd. A driving device comprises a piezoelectric actuator PZ, the driving shaft DS and the lens holder Hd. The driving circuit may be placed on the base B and may be connected with the piezoelectric actuator PZ through electrical wires.

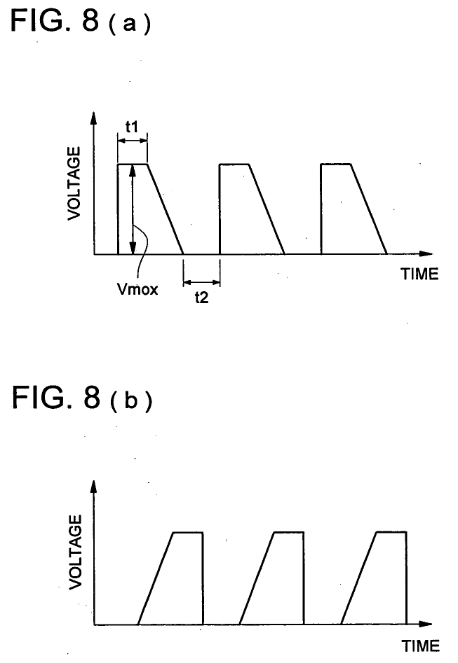

Next, the driving method for lens L1 by the optical unit CU will be explained. In general, the movement amount of a layered piezoelectric actuator PZ when voltage is applied is small but generated power is large and its response is sharp. Accordingly, when applying pulse voltage of substantially saw tooth waveform having a sharp start up and slow down waveforms, the piezoelectric actuator sharply extends at the start up of the waveform and slowly contracts at the down waveform as shown in FIG. 8(a). Consequently, the driving shaft DS is pushed to this side by the impulse force as shown in FIG. 6, but the lens holder Hd holding the lens L1 does not move with the driving shaft DS due to the inertia and remains the same position due to the slipping occurred between the driving aperture DA and the driving shaft DS (there is a case that the lens holder DS move a little bit). On the other hand, since the driving shaft DS slowly moves back when the waveform falls down comparing with start up waveform, the driving shaft DS does not move against the driving aperture DA but move back together with driving shaft DA in the rear direction (wall W side) in FIG. 6. Namely, the lens holder Hd can be continuously moved with a predetermined rate by applying pulse waveform having frequency range from several hundred Hz to several tens thousand Hz. It is apparent, based on the explanation above, that as shown in FIG. 8(b), lens holder Hd can be moved in the reverse direction when applying a pulse waveform having a slow start and sharp down waveforms. A stepping motor may also move the lens holder Hd.

In this embodiment of the present invention, as shown in FIG. 6, an expander lens EXP has two lenses L1 and L2, the expander lens including at least a negative lens and a positive lens and being arranged to move one of the lens in an optical axis direction. However, two lenses may also be simultaneously moved. Further, with regard to the expander lens, it may have three-lens configuration including at a negative lens and at least a positive lens. Particularly, when the negative lens is designated as a moving lens, it is possible to designate a lens having smaller diameter as a moving lens. Since the moving lens is small in size and light in weight when designating the negative lens as a moving lens, power consumption, when driving the actuator, can be controlled lower comparing with the case when driving a positive lens. Accordingly, it is preferable to designate a negative lens as a moving lens.

With regard to an optical pickup of the embodiment of the present invention, it is possible to reproduce and or record information from or onto four kinds of optical discs, BD, HD, DVD and CD. Here, spherical aberration focused onto the information recording surface occurs due to the differences of the thicknesses of the protective substrates of these optical discs. Accordingly, in this embodiment, the lens L1 of the expander lens EXP is arranged to move in an optical axis direction and change the diverging angle of light flux passing through the expander lens to correct the spherical aberration corresponding to an optical disc to be used in order to record and or reproduce information onto or from the optical disc. Since the driving device shown in this embodiment is relatively low cost and have a small size structure, the optical pick apparatus can be built in low cost and in a compact size.

Further, it is also possible to arbitrarily change the rim intensity distribution of the light beam spot by driving lens L1 of the expander lens EXP. A collimator lens, a zoomed collimator lens or a zoomed expander lens may be used instead of the expander lens EXP. A liquid crystal element may also be used as a correction element.

Further, it is also possible to drive and control the piezoelectric actuator to reduce the aberration by detecting the current aberration based on the signals from a photo detector for receiving reflected light flux from the information recording surface of an optical disc by a spherical aberration detection device (now shown) in the aberration correction method described above.

### Second Embodiment

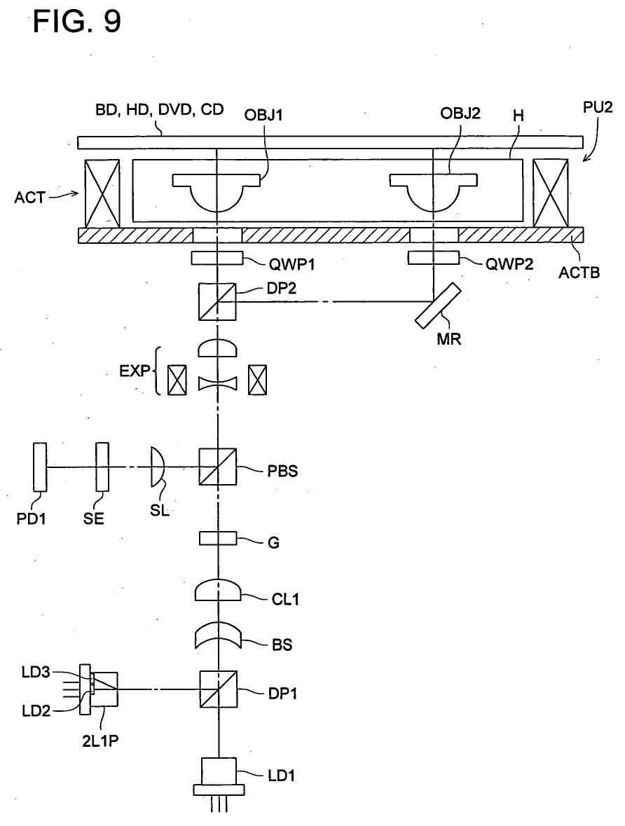

FIG. 9 illustrates a schematic sectional view of an optical pickup apparatus, according to the second embodiment, capable of compatibly recording and or reproducing information onto or from all types of optical information recording media such as BD (a first optical information recording medium), HD (a second optical information recording medium), DVD (a third optical information recording medium) and CD (a fourth optical information recording medium). This embodiment comprises a so-called two lasers in one package 2L1P in which a second semiconductor laser LD2 and a third laser diode LD3 are installed in a package (it is called a light source unit).

The embodiment uses a first semiconductor laser LD1 and a two-lasers in one page 2L1P in which a second semiconductor laser LD2 and a third laser diodes LD3 are installed. However, three lasers in one package 3L1P may be used in the present embodiment. In this case, it may be possible to focus light flux onto BD, HD and DVD by using a first objective lens. OBJ1 and to focus light flux onto CD by using a second objective lens OBJ2 in order to record and or reproduce information onto and or from those discs. It may also be possible to focus light flux onto BD and HD by using a first objective lens OBJ1 and to focus light flux onto DVD and CD by using a second objective lens OBJ2 in order to record and or reproduce information onto and or onto those discs.

An actuator ACT movably supports a lens holder H supporting the first objective lens OBJ1 and the second objective lens OBJ2 so that the lens holder H moves at least in two-dimensional directions. The actuator ACT has an actuator base ACTB so that the position of the actuator base ACT can be adjustable against an optical pickup frame (not show). Two openings are formed on the actuator base ACTB. One opening is arranged so that light flux incident into the first objective lens OBJ1 pass through the opening when recording and or reproducing information onto or from BD, HD or DVD, and another opening is arranged so that light flux incident into the second objective lens OBJ2 pass through the opening when recording and or reproducing information onto or from CD.

Firstly, the operation for recording and or reproducing information onto or from BD will be explained. In FIG. 9, light flux emitted from a first semiconductor laser diode LD1 (wavelength λ1=380 nm-450 nm) are shaped into parallel light flux after passing through a dichroic prism DP1, a beam shaper BS which corrects the light flux and a first collimator lens CL1. The light flux outputted from the first collimator lens CL1 pass through a diffraction grating G for separating light flux emitted from a light source into main beams used to recording and reproducing information and the sub beams used for detecting tracking error signal, and further a polarization beam splitter PBS and an expander lens EXP. The expander lens EXP changes the light beam diameter of parallel light flux. In this case the expander lens EXP expands the light beam diameter, and at least one of optical elements in the expander lens EXP is arranged to move in the optical axis direction.

Light flux passed through the expander lens EXP pass through a second dichroic prism DP2 and a first quarter wave panel. QWP1 and the first objective lens OBJ1 forms a converged light spot onto an information recording surface after passing through a protective layer (thickness t1=0.1 mm) of BD.

The light flux modulated by information pits on the information recording surface pass back through the objective lens OBJ1, the first quarter wave plate QWP1 and the expander lens EXP. Then the polarized beam splitter PBS reflects the light flux. The light flux pass through a sensor lens SL and an optical axis correction element SE, and reach to a first photo detector PD1. The read out signal of information recorded on BD can be obtained by using the output signal of the first photo detector PD1. The optical axis correction element SE is arranged to correct the optical axis displacement of the second and third lasers LD2 and LD3 so that the light flux emitted from both light sources focus onto the optimum position on the first photo detector. The light flux from the first laser LD1 pass through the optical axis correction element SE without any correction.

Further, focal point detection and track detection will be conducted by detecting the change of the light beam amount resulting from the beam spot shape changes on the first photo detector PD1 and the change of the light beam amount resulting from the position change of the light beam spot on the first photo detector PD1. Based on these detections, the actuator ACT moves the first objective lens OBJ1 together with the lens holder H so that the light flux from the first semiconductor laser LD1 are focused on the information recording surface of BD.

Next, the operation for recording and or reproducing information onto or from HD will be explained. In FIG. 9, light flux emitted from a first semiconductor laser diode LD1 (wavelength λ1=380 nm-450 nm) are shaped into parallel light flux after passing through the dichroic prism DP1, the beam shaper BS which corrects the shape of the light flux and the first collimator lens CL1. The light flux outputted from the first collimator lens CL1 pass through the diffraction grating G for separating light flux emitted from the light source into main beams used for recording and reproducing information and the sub beams used for detecting tracking error signal, the polarization beam splitter PBS and an expander lens EXP. A part of lenses of the expander lens EXP being a correction element is moved in the optical axis direction by a driving device as shown in FIG. 6, to correct spherical aberration caused by the differences between the thicknesses of the protective substrates of BD and HD. A diaphragm (not shown) may be used to correspond to the differences between the numerical apertures corresponding to BD and HS to be used. The objective lens may also have an aperture-limiting function, for example, in an area between an effective diameter area corresponding to a numerical aperture when BD is used and an effective diameter area corresponding to a numerical aperture when HD is used so that the objective lens focuses light flux without aberration against a BD disc protective substrate, and the objective lens focuses light flux by generating aberration against a HD protective substrate when recording and or reproducing information onto or from the optical information recording surface of HD in order not to interfere the converged light spot by eliminating flare caused by unnecessary light flux. The aperture-limiting function can be realized by using a phase structure or by providing, at least, an aspherical surface having two areas, one in the inside of a HD numerical aperture area and another in the outside of the HD numerical aperture area.

Light flux passed through the expander lens EXP pass through the second dichroic prism DP2 and a first quarter wave panel QWP1, and the first objective lens OBJ1 focuses the light flux and forms a converged light spot onto an information recording surface after passing through a protective layer (thickness t3=0.6 mm) of HD.

The light flux modulated by information pits on the information recording surface pass back through the first objective lens OBJ1, the first quarter wave plate QWP1, the second dichroic prism DP2 and the expander lens EXP, and are reflected by the polarized beam splitter PBS. Then the light flux pass through a sensor lens SL and the optical axis correction element SE. The light flux reach to a first photo detector PD1. The readout signal of information recorded on HD can be obtained by using the output signal of the first photo detector PD1.

Also, focal point detection and track detection will be conducted by detecting the change of light beam amount resulting from the beam spot shape changes on the first photo detector PD1 and the change of light beam amount resulting from the position change of the light beam spot on the first photo detector PD1. Based on these detections, the actuator ACT moves the first objective lens OBJ1 together with the lens holder H so that the light flux from the first semiconductor laser LD1 are focused on the information recording surface of HD.

Next, the operation for recording and or reproducing information onto or from DVD will be explained. Light flux emitted from a second semiconductor laser diode LD2 (wavelength λ2=600 nm-700 nm) are shaped into parallel light flux after being reflected by a first dichroic prism DP1 and passing through a beam shaper BS which corrects the light flux and a first collimator lens CL1. The light flux outputted from the first collimator lens CL1 pass through a diffraction grating G, a polarization beam splitter PBS and an expander lens EXP.

The light flux having had passed through the expander lens EXP can select one of the paths described below. With regard to the first path, the light flux emitted from the second semiconductor laser LD2 are focused by the first objective lens OBJ1 onto the information recording surface through a DVD protective layer (thickness t3=0.6 mm) after passing through the second dichroic prism DP2 and the first quarter wave plate QWP1.

The light flux modulated by information pits on the information recording surface pass back through the objective lens OBJ1, the first quarter wave plate QWP1, the second dichroic prism DP2 and the expander lens EXP. Then the polarized beam splitter PBS reflects the light flux. The light flux pass through a sensor lens SL and an optical axis correction element SE, and reach to a first photo detector PD1. The read out signal of information recorded on BD can be obtained by using the output signal of the first photo detector PD1.

With regard to the second optical path, the light flux emitted from the second semiconductor laser LD2 are reflected by the second dichroic prism DP2 and mirror MR. Then the light flux are focused onto the information recording surface of DVD through the protective layer (thickness t3=0.6 mm) by the second objective lens OBJ2 after passing through the second quarter wave plate QWP2.

The light flux modulated by information pits on the information recording surface pass back through the second objective lens OBJ2 and the second quarter wave plate QWP2. The light flux are reflected by the mirror MR and the second dichroic prism DP2. Then the light flux pass through the expander lens EXP, and reflected by the polarized beam splitter PBS. Then the light flux pass through a sensor lens SL and the optical axis correction element SE. The light flux reach to a first photo detector PD1. The readout signal of information recorded on DVD can be obtained by using the output signal of the first photo detector PD1.

Focal point detection and track detection will be conducted by detecting the change of light beam amount resulting from the beam spot shape changes on the first photo detector PD1 and the change of light beam amount resulting from the position change of the light beam spot on the first photo detector PD1. Based on these detections, the actuator ACT moves the first objective lens OBJ1 or the second objective lens OBJ2 together with the lens holder H so that the light flux from the first semiconductor laser LD1 are focused on the information recording surface of DVD.

Further, the operation for recording and or reproducing information onto or from CD will be explained. Light flux emitted from a third semiconductor laser diode LD3 (wavelength λ3=700 nm-800 nm) of a two lasers one package are reflected by the first dichroic prism PD1 and the shape of the light flux are corrected by passing through the beam shaper BS. Then the light flux are shaped into parallel light flux after passing through the first collimator lens. CL1. The light flux outputted from the first collimator lens CL1 pass through the diffraction grating G, the polarized beam splitter PBS and expander lens EXP.

The light flux passed through the expander lens EXP are reflected by the second dichroic prism DP2 and the mirror MR. Then the light flux pass through the second quarter wave plate QWP2 and focused onto the information recording surface of CD by a second objective lens OBJ2 after passing through a protective layer (thickness t4=1.2 mm) of CD.

The light flux modulated by the information pit on the information recording surface pass back through the second objective lens OBJ2, the second quarter wave plate QWP2, and reflected by the mirror MR and second dichroic prism DP2. The light flux pass through the expander lens EXP and are reflected by the polarized beam splitter PBS. Then the light flux pass through the sensor lens SL and the optical axis displacement generated on the structure of two laser one package are corrected. Then the light flux are entering to the first photo detector PD1. Accordingly, the readout signal of the information recorded on the information surface of CD can be obtained by using the signal output from the first photo detector PD1.

Focal point detection and track detection will be conducted by detecting the change of light beam amount resulting from the beam spot shape changes on the first photo detector PD1 and the change of light beam amount resulting from the position change of the light beam spot on the first photo detector PD1. Based on these detections, the actuator ACT moves the second objective lens OBJ2 together with the lens holder H so that the light flux from the third semiconductor laser LD3 are focused on the information recording surface of CD.

With regard to the dichroic prisms DP1 and DP2 (it may be a dichroic mirror) as shown in FIG. 9, they are, for example, prisms, through which, at least, light flux having wavelength λ1 pass and which reflect light flux having wavelength λ. In case that the first objective lens OBJ1 is used to focus light flux onto DVD, the dichroic prism having a function to pass light flux having wavelength λ2 through therein may be selected. In case that the light flux having wavelength λ2 are focused on to the DVD through the first objective lens OBJ1, a dichroic prism having a function to pass the light flux having wavelength, λ2 may be selected. In case that the second objective lens OBJ2 is used to focus light flux onto DVD, the dichroic prism having function to reflect light flux having wavelength λ2 may be selected.

In the embodiment shown in FIG. 9, the first objective lens OBJ1 is arranged to focus light flux from a light source onto at least BD and HD, and the second objective lens OBJ2 is arranged to focus light flux from a light source onto at least CD. It may also be possible that the first objective lens OBJ1 is arranged to focus light flux from a light source onto at least CD and the second objective lens OBJ2 is arranged to focus light flux from a light source onto at least BD and HD. In this case, the dichroic prism reflects light flux having wavelength λ1 and passes light flux having wavelength λ3. If the first objective lens OBJ1 is arranged to focus light flux onto DVD by using a light flux having wavelength λ2, then the dichroic prism having function to pass wavelength λ2 has to be selected. If the second objective lens OBJ2 is arranged to focus light flux onto DVD by using a light flux having wavelength λ2, then the dichroic prism having function to reflect wavelength λ2 has to be selected.

### Third Embodiment

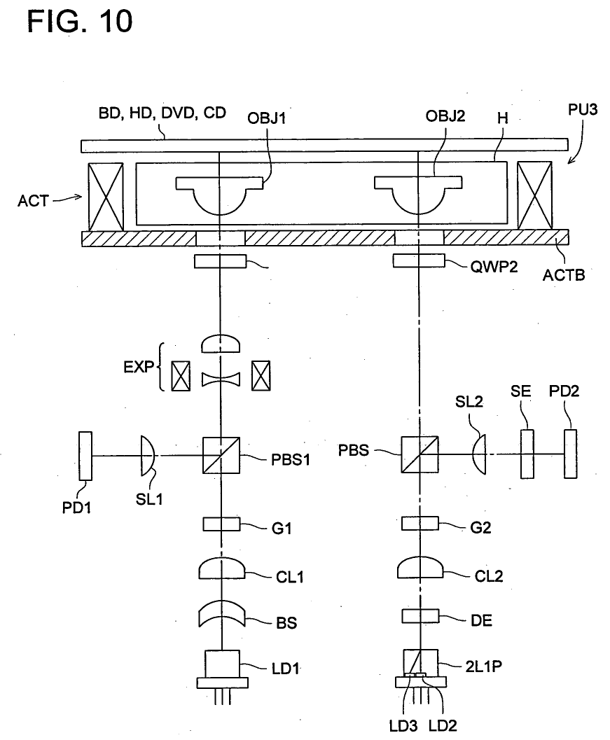

FIG. 10 illustrates a schematic sectional view of an optical pickup apparatus, according to the third embodiment, capable of compatibly recording and or reproducing information onto or from all types of optical information recording media such as BD (a first optical information recording medium), HD (a second optical information recording medium), DVD (a third optical information recording medium) and CD (a fourth optical information recording medium). This embodiment comprises a so-called two lasers in one package 2L1P in which a second semiconductor laser LD2 and a third laser diode LD3 are installed in a package (it is called a light source unit).

In this embodiment, a diffraction element DE is provided between a two lasers in one package 2L1P and a second collimator lens CL2. It is preferable that the diffraction element DE is also used as a cover of the two lasers in one package 2L1P.

The embodiment uses a first semiconductor laser LD1 and a two-lasers in one page 2L1P which includes a second semiconductor laser LD2 and a third laser diodes LD3. However, three lasers in one package 3L1P may also be used in the present embodiment. In this case, it is preferable to focus light flux onto BD, HD and DVD by using a first objective lens OBJ1 and to focus light flux onto CD by using a second objective lens OBJ2 in order to record and or reproduce information onto and or onto those discs.

In this embodiment, the diffraction element DE is arranged to has a diffraction structure on its optical surface having the most effective diffraction efficiency in zero-order diffracted light flux when light flux from the second semiconductor laser LD2 and the most effective diffraction efficiency in n-order diffracted light flux when light flux from the third semiconductor laser LD3. By using the diffraction effect, even though the second semiconductor laser LD2 is placed on the optical axis of the optical pickup apparatus and the third semiconductor laser LD3 is placed away from the optical axis, when the light flux emitted from the third semiconductor laser LD3 come out from the two lasers in one package 2L1P, it can be arranged that the optical axes of the light flux form third semiconductor laser LD3 and the second semiconductor laser LD2 coincide. Accordingly, it is possible to avoid the displacement of an optical axis on the'second photo detector PD2.

A lens holder H supporting the first objective lens OBJ1 and the second objective lens OBJ2 is supported by an actuator ACT so that the lens holder H moves at least in two-dimensional directions. The actuator ACT has an actuator base ACTB so that the position of the actuator base ACTB can be adjustable against an optical pickup frame (not show). Two openings are formed on the actuator base ACTB. One opening is arranged so that light flux incident into the first objective lens OBJ1 pass through the opening when recording and or reproducing information onto or from BD, HD or DVD, and another opening is arranged so that light flux incident into the second objective lens OBJ2 pass through the opening when recording and or reproducing information onto or from CD.

Firstly, the operation for recording and or reproducing information onto or from BD will be explained. In FIG. 10, light flux emitted from a first semiconductor laser LD1 (wavelength λ1=380 nm-450 nm) are shaped into parallel light flux after passing through a beam shaper BS which corrects the light flux and a first collimator lens CL1. The light flux outputted from the first collimator lens CL1 pass through a diffraction grating G for separating light flux emitted from a light source into main beams used for recording and reproducing information and the sub beams used for detecting tracking error signal, and a first polarization beam splitter PBS1 and an expander lens EXP. The expander lens EXP changes the diameter of parallel light flux. In this case, the expander lens EXP expands the light beam diameter, and at least one of optical elements in the expander lens EXP is arranged to move in the optical axis direction.

Light flux passed through the expander lens EXP pass through a first quarter wave panel QWP1 and the first objective lens OBJ1 forms a converged light spot onto an information recording surface after passing through a protective layer (thickness t1=0.1 mm) of BD.

The light flux modulated by information pits on the information recording surface pass back through the objective lens OBJ1, the first quarter wave plate QWP1 and the expander lens EXP. Then the first polarized beam splitter PBS1 reflects the light flux. The light flux passed through a first sensor lens SL1 reach to a first photo detector PD1. The read out signal of information recorded on BD can be obtained by using the output signal of the first photo detector PD1.

Also, focal point detection and track detection will be conducted by detecting the change of light beam amount resulting from the beam spot shape changes on the first photo detector PD1 and the change of light beam amount resulting from the position change of the light beam spot on the first photo detector PD1. Based on these detections, the actuator ACT moves the first objective lens OBJ1 together with the lens holder H so that the light flux from the first semiconductor laser LD1 are focused on the information recording surface of BD.

Next, the operation for recording and or reproducing information onto or from HD will be explained. In FIG. 10, light flux emitted from the first semiconductor laser LD1 (wavelength λ1 380 nm-450 nm) are shaped into parallel light flux after passing through the beam shaper BS which corrects the shape of the light flux and the first collimator lens CL1. The light flux outputted from the first collimator lens CL1 pass through the diffraction grating G for separating light flux emitted from a light source into main beams used for recording and reproducing information and the sub beams used for detecting tracking error signal, the first polarization beam splitter PBS1 and the expander lens EXP. A part of lens of an expander lens EXP being a correction element is moved in the optical axis direction by the driving device as shown in FIG. 6, to correct spherical aberration caused by the differences between the thicknesses of the protective substrates of BD and HD. A diaphragm (not shown) may be used to correspond the differences between the numerical apertures of BD and HS. The objective lens may also have an aperture-limiting function, for example, in an area between an effective diameter area corresponding to a numerical aperture when BD is used and an effective diameter area corresponding to a numerical aperture when HD is used so that the objective lens focuses light flux without aberration against a BD disc protective substrate, and the objective lens focuses light flux by generating aberration against a HD protective substrate when recording and or reproducing information onto or from the optical information recording surface of HD in order not to interfere the converged light spot by eliminating flare caused by unnecessary light flux. The aperture-limiting function can be realized by using a phase structure or by providing, at least, an aspherical surface having two areas, one in the inside of a HD numerical aperture area and another in the outside of the HD numerical aperture area.

Light flux passed through the expander lens EXP pass through a first quarter wave panel QWP1 and the first objective lens OBJ1 forms a converged light spot onto an information recording surface after passing through a protective layer (thickness t1=0.1 mm) of HD.

The light flux modulated by information pits on the information recording surface pass back through the objective lens OBJ1, the first quarter wave plate QWP1 and the expander lens EXP. Then the first polarized beam splitter PBS1 reflects the light flux. The light flux passed through a first sensor lens SL1 reach to a first photo detector PD1. The read out signal of information recorded on HD can be obtained by using the output signal of the first photo detector PD1.

Also, focal point detection and track detection will be conducted by detecting the change of light beam amount resulting from the beam spot shape changes on the first photo detector PD1 and the change of light beam amount resulting from the position change of the light beam spot on the first photo detector PD1. Based on these detections, the actuator ACT moves the first objective lens OBJ1 together with the lens holder H so that the light flux from the first semiconductor laser LD1 are focused on the information recording surface of HD.

Next, the operation for recording and or reproducing information onto or from DVD will be explained. The light flux emitted from the second semiconductor laser LD2 (wavelength λ2=600 nm-700 nm) of two lasers in one package are formed into parallel light flux after passing through the diffraction element DE and the second collimator lens CL2. The light flux outputted from the second collimator lens CL2 pass through the second diffraction grating G2 and further pass through the second polarized beam splitter PBS2.

The light flux passed through the second polarized beam splitter PBS2 pass through the second quarter wave plate QWP2. The second objective lens OBJ2 focuses the light flux onto the information recording surface through the DVD protective layer (thickness t3=0.6 mm).

Then the light flux modulated by the information pits on the information recording surface pass back through the second objective lens OBJ2 and the second quarter wave plate QWP2. The light flux are reflected by the second polarized beam splitter and pass through the'sensor lens SL and the optical axis correction element SE. Then the light flux incident into the second photo detector PD2. The readout signal of information recorded on the DVD can be obtained by using the output signal of the second photo detector PD2.

Also, focal point detection and track detection will be conducted by detecting the change of light beam amount resulting from the beam spot shape changes on the second photo detector PD2 and the change of light beam amount resulting from the position change of the light beam spot on the second photo detector PD2. Based on these detections, the actuator ACT moves the second objective lens OBJ2 together with the lens holder H so that the light flux from the second semiconductor laser LD2 are focused on the information recording surface of DVD.

Further, the operation for recording and or reproducing information onto or from CD will be explained. Light flux emitted from a third semiconductor laser diode LD3. (wavelength λ3=700 nm-800 nm) of a two lasers in one package pass through the diffraction element DE. Then the light flux are shaped into parallel light flux after passing through the second collimator lens CL2. The light flux outputted from the second collimator lens CL2 pass through the second diffraction grating G2, the second polarized beam splitter PBS2.

The light flux passed through the second polarized beam splitter PBS2 pass through the second quarter wave plate QWP2 and are focused onto the information surface of CD through the protective layer (thickness t4=1.2 mm) by the second objective lens OBJ2.

Then, the light flux modulated by the information pits of the information recording surface pass back through the second objective lens OBJ2 and the second quarter wave plate QWP2. The light flux are reflected by the second polarized beam splitter PBS2 and pass through the sensor SL and the optical axis correction element SE. The displacement of the optical axis generated on the structure of the two lasers in one package is corrected by the optical axis correction element SE and incident onto the receiving surface of the second photo detector PD2. The readout signal of information recorded on the CD is obtained by reading the output signal of the second photo detector PD2.

Focal point detection and track detection will be conducted by detecting the change of light beam amount resulting from the beam spot shape changes on the second photo detector PD2 and the change of light beam amount resulting from the position change of the light beam spot on the second photo detector PD2. Based on these detections, the actuator ACT moves the second objective lens OBJ2 together with the lens holder H so that the light flux from the third semiconductor laser LD3 are focused on the information recording surface of CD.

### Fourth Embodiment

In First Embodiment, Second Embodiment and Third Embodiment, the embodiment capable of conducting recording or reproducing information to compatibly all of the four kinds of optical information recording mediums of BD (herein, the first optical information recording medium), HD (herein, the second optical information recording medium), DVD (herein, the third optical information recording medium) and CD (herein, the third optical information recording medium) is explained. However, the structures of these embodiments are usable as a structure to conduct recording or reproducing information to compatibly three kinds of optical information recording mediums.

For example, in the structure of Second Embodiment shown in FIG. 9 and in the structure of Third Embodiment shown in FIG. 10, by making these structures to be a structure in which LD2 is not used, recording or reproducing information for BD and HD can be conducted by the first objective lens OBJ1 and recording or reproducing information for CD can be conducted by the second objective lens OBJ2.

Further, in the structure of Third Embodiment shown in FIG. 10, by making these structures to be a structure in which LD3 is not used, recording or reproducing information for BD and HD can be conducted by the first objective lens OBJ1 and recording or reproducing information for DVD can be conducted by the second objective lens OBJ2.

<Another Embodiment of BD/HD Compatible Optical System>

Another Embodiment 1 of the Compatible Optical System

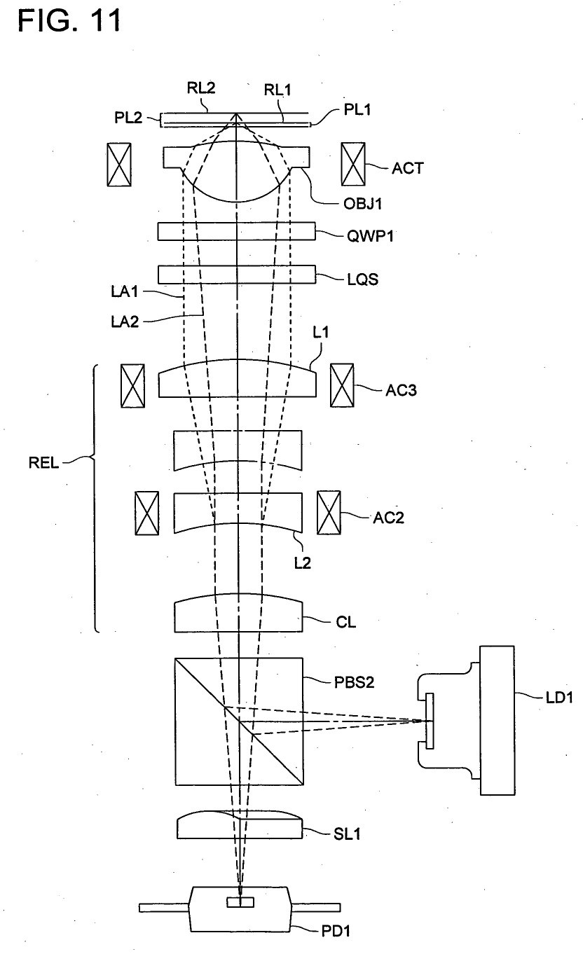

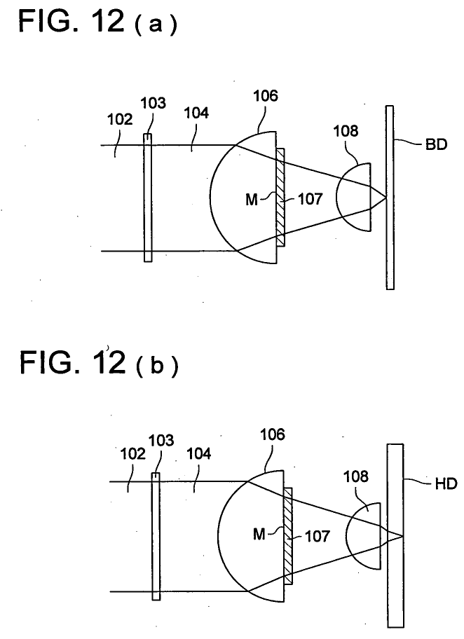

FIG. 11 is a view for explaining the other embodiment by which the optical system to conduct the recording or reproducing of the information to BD (herein, the first optical information recording medium) and HD (herein, the second optical information recording medium) in the optical pick-up apparatus PU3 of FIG. 10 is replaced with another embodiment. A point largely different from the optical system (hereinafter, called the optical system for the first semiconductor laser) corresponding to the optical path which the light flux projected from the first semiconductor laser passes from the first semiconductor laser LD1 shown in FIG. 10 to the information recording surface of BD or HD, and from the information recording surface of BD or HD to the first optical detector PD11, is that, in place of the expander lens, the lens group having the zoom function is arranged.

Another embodiment of the optical system for the first semiconductor laser will be specifically described below by using FIG. 11.

In the optical axis direction of the light flux projected from the first semiconductor laser LD1, the first polarizing beam splitter PBS2 whose shape is almost square is provided. In the optical axis direction of the light spectral-ized by this first polarizing beam splitter PBS2, a collimator CL, relay lens group REL composed of the second lens group L2 and the first lens group L1, liquid crystal shutter LQS, the first ¼ wavelength plate QWP1, the first objective lens OBJ1 are successively arranged, and at the position opposite to the first ¼ wavelength plate QWP1 with the first objective lens OBJ1 between them, BD or HD which is the optical information recording medium is arranged.

Herein, the first lens group L1 is composed of a single lens whose shape of one surface of the side opposite to the objective lens is formed into almost convex. The single lens which composes the first lens group L1, is formed of plastic whose water absorption coefficient is less than 0.1%, specific gravity is less than 1.5, and has the positive refractive power.

Further, the second lens group L2 has the negative refractive power, and the refractive power p₁ of such a second lens group L2 and the refractive power p₂ of the first lens group L1 satisfy the following conditional expression (1).
−3.5≦p₁/p₂≦−1.8 (1)

In this manner, in the relay lens group, from the side close to the first objective optical element, the first lens group having the positive refractive power, and the second lens group having the negative refractive power are successively arranged, and the second lens group is a movable lens group and a single lens composition having the negative refractive power, and it is preferable that the relay lens group satisfies the above conditional expression (1).

On the one hand, on the side opposite to the collimator CL sandwiching the first polarizing beam splitter PBS2, the first sensor lens SL1 for adding the astigmatism to the, reflection light flux from the information recording surface of BD or HD, and the first light detector PD1 for BD and HD, detecting the reflection light flux are successively arranged.

Further, to the second lens group L2 and the first lens group L1 in the above-described relay lens group REL, one-axis actuators AC2, AC3 are respectively provided, and when the recording or reproducing of the information is conducted on BD, so as to project the parallel light flux to the first objective lens OBJ1, the interval between the second lens group L2 and the first lens group L1 is optimized by the one-axis actuator AC2.

On the one hand, when the recording or reproducing of the information is conducted on HD, the interval between the second lens group L2 and the first lens group L1 is optimized so as to project the diverging light flux to the first objective lens OBJ1, and so as to be smaller than the interval in the case where the recording or reproducing of BD is conducted, by the one-axis actuator AC2.

Herein, the composite focal distance TF₁ of the relay lens group REL and the first objective lens OBJ1 and the numerical aperture NA₁ of the first objective lens OBJ1 when the recording or reproducing of BD is conducted, and the composite focal distance TF₂ of the relay lens group REL and the first objective lens OBJ1 and the numerical aperture NA₂ of the first objective lens OBJ1, when the recording or reproducing of HD is conducted, satisfy the following conditional expression (2).
0.8≦NA₁·TF₁/(NA₂·TF₂)≦1.2 (2)

Further, it is more preferable to satisfy the following conditional expression (3).
0.95≦NA₁™TF₁/(NA₂·TF₂)≦1.05 (3)

Further, in the case where the recording or reproducing of HD is conducted, when the first lens group L1 is tracked in the direction perpendicular to the optical axis by the one-axis actuator AC3, the lens group L1 is moved in the direction reverse to the first objective lens OBJ1.

Herein, the absolute value TO of the movement amount in the direction perpendicular to the optical axis at the time of tracking of the first objective lens OBJ1 and the absolute value TR of the movement amount in the direction perpendicular to the optical axis of the relay lens group REL satisfy the following conditional expression (4).
0.6≦TO/TR≦1.5 (4)

Further, the one-axis actuator AC2, AC3 described above, corresponds also to BD which can record in the multi-layers. More specifically, in order to make access to the information recording layer having the different depth in the same BD, when the interval between the second lens group L2 and the first lens group L1 is optimized by the one-axis actuator, that is, when the magnification of the first objective lens OBJ is changed, the first objective lens OBJ is displaced in the optical axis direction, that is, the spherical aberration generated when so called focus jump is conducted, is corrected.

Herein, the numerical aperture NA1 of the first objective lens OBJ when the recording or reproducing of BD is conducted, is more than 0.8, the movement amount δ of the second lens group L2 moved corresponding to the recording operation satisfies the following conditional expression (5).
7.5≦(NA₁·δ)/(t₂−t₁)≦22 (5)

Where, t₁ is the protective substrate thickness of BD (the first optical information recording medium), t₂ is the protective substrate thickness of HD (the second optical information recording medium).

As described above, between the first light source and the first objective optical element, the rely lens group having the movable lens group which can move along the optical axis direction, is provided, and the numerical aperture of the first optical objective element when the information is reproduced or recorded on the first optical information recording medium is NA1 and in the case where the information is reproduced or recorded on the second optical information recording medium, when the maximum movement amount of the movable lens group moved from the position of the movable lens group when the information is reproduced or recorded on the first optical information recording medium is δ, it is preferable to satisfy the above conditional expression (5).

Hereupon, by using the one-axis actuators AC2, AC3 described above, in the same manner as BD, it may also be structured so as to correspond to HD which can record on the multi-layer. In this case, to the optical pick-up apparatus PU3, a recording layer discrimination means for discriminating which recording layer is the information recording layer on which the first objective lens OBJ1 focuses, is provided.

Further, to the optical pick-up apparatus PU3 described above, a control means for discriminating the kind of the optical disk (for example, BD or HD) accommodated in a disk tray (not shown), and for moving the second lens group L2 to the optimum position, is provided.

Further, a zoom lens function of the relay lens group REL in the present embodiment is a 2-group composition in which, from the side close to the first objective lens OBJ1, the first lens group L1 and second lens group L2 are successively arranged, however, it is not particularly limited to this, for example, a 3-group composition in which the third lens group having the positive refractive power is added to the side opposite to the first lens group L1 with the second lens group L2 between them may also be allowable. In this case, in also the third lens group, in the same manner as the second lens group L2 and the first lens group L1 described above, the one-axis actuator is provided, and the interval to the adjoining second lens group L2 is optimized.

In the case of the relay lens group having the above-described zoom lens function of the 3-group composition, the first lens group L1 is composed of a single lens whose one surface of the reversal side to the side opposite to the objective lens is formed into almost concave, and the third lens group is composed of a single lens whose one surface of the side opposite to the objective lens is formed into almost convex. The single lens composing the third lens group, is formed of plastic whose water absorption coefficient is less than 0.1%, and the specific gravity is less than 1.5.

The refractive power p₃ of such a third lens group L3, the above-described refractive power p₁ of the second lens L2 and the refractive power p₂ of the first lens group L1 satisfy the following conditional expressions (6) and (7).
0.7≦p₁/p₃<1.6 (6)
−5≦p₂/p₃≦−3.7 (7)

As described above, in the relay lens group, from the side close to the first objective optical element, the first lens group having the positive refractive power, the second lens group having the negative refractive power, the third lens group having the positive refractive power, are successively arranged, and the second lens group and the third lens group are movable lens groups, and it is preferable that the relay lens group satisfies the above-described conditional expressions (6) and (7).

Further, in the same manner as the relay lens group REL provided with the zoom lens function of the above-described 2-group composition, the composite focal distance TF₁ of the relay lens group REL and the first objective lens OBJ1 when the recording or reproducing of BD is conducted, and the numerical aperture NA₁ of the first objective lens OBJ1, and the composite focal distance TF₂ of the relay lens group REL and the first objective lens OBJ1 when the recording or reproducing of HD is conducted, and the numerical aperture NA₂ of the first objective lens OBJ1, satisfy the following conditional expression (8).
0.8≦NA₁·TF₁/(NA₂·TF₂)≦1.2 (8)

Further, in the same manner, it is more preferable to satisfy the following conditional expression (9).
0.95≦NA₁·TF₁/(NA₂·TF₂)≦1.05 (9)

Further, in the same manner as the relay lens group REL provided with the zoom lens function of the above-described 2-group composition, the absolute value TO of the movement amount in the direction perpendicular to the optical axis at the time of tracking of the first objective lens OBJ1 and the absolute value TR of the movement amount in the direction perpendicular to the optical axis of the relay lens group REL, satisfy the following conditional expression (10).]
0.6≦TO/TR≦1.5 (10)

Next, the operation of the above-described optical system for the first semiconductor laser will be described below.

Because the optical system for the first semiconductor laser in the present embodiment respectively conducts the different operation due to the kind of optical disks (BD and HD), that is, due to the difference of the protective substrate thickness, the details of the operation modes to the optical disks having the first protective substrate PL1 of BD (the first optical information recording medium) and the second protective substrate PL2 of HD (the second optical information recording medium) will be respectively described below.

Initially, BD, that is, the operation to the optical disk having the first protective substrate PL1 will be described.

The light is projected from the first semiconductor laser LD1 at the time of recording operation of the information to the optical disk having the first protective substrate PL1 or at the time of reproducing operation of the information recorded in the optical disk having the first protective substrate PL1. The projected light is reflected by the first polarizing beam splitter PBS2, and is made into the parallel light by the collimator CL. Then, the light passes the second lens group L2, the first lens group L1, liquid crystal shutter LQS, the first ¼ wavelength plate QWP1 and the first objective lens OBJ1 (the ray LA1), and forms the light converging spot on the recording surface RL1 of the optical disk having the first protective substrate thickness PL1. In this case, by the one-axis actuator AC2, in the lens group composing the relay lens group REL, the interval between the second lens group L2 and the first lens group L1 is optimized, and the parallel light flux is projected.

The light formed the light converging spot is modulated by the information pit on the information recording surface RL1 of the optical disk having the first protective substrate PL1, and reflected by the information recording surface RL1. Then, after this reflection light passes the first objective lens OBJ1, the first ¼ wavelength plate QWP1, liquid crystal shutter LQS, relay lens REL, the first polarizing beam splitter PBS2, passes the first sensor SL1, and the astigmatism is given, and light received by the first light detector PD1. After that, such an operation is repeated, and the recording operation of the information to the optical disk having the first protective substrate PL1 or the reproducing operation of the information recorded in the optical disk having the first protective substrate PL1 is completed.

Next, HD, that is, the operation to the optical disk having the second protective substrate PL2 will be described.

The light is projected from the first semiconductor laser LD1 at the time of recording operation of the information to the optical disk having the second protective substrate PL2 or at the time of reproducing operation of the information recorded in the optical disk having the second protective substrate PL2. The projected light is reflected by the first polarizing beam splitter PBS2, and is made into the parallel light by the collimator lens CL. Then, the light passes the second lens group L2, the first lens group L1, liquid crystal shutter LQS, the first ¼ wavelength plate QWP1, and the first objective lens OBJ1, (ray LA2), and forms the light converging spot on the information recording surface RL2 of the optical disk having the second protective substrate PL2. In this case, by the one-axis actuator AC2, in the lens group composing the relay lens group REL, the interval between the second lens group L2 and the first lens group L1 is optimized so as to be smaller than at the time of the operation to BD, and the divergent light flux is projected.

The light formed the light converging spot is modulated by the information pit on the information recording surface RL2 of the optical disk having the second protective substrate PL2, and reflected by the information recording surface RL2. Then, after this reflection light passes the first objective lens OBJ1, the first ¼ wavelength plate QWP1, liquid crystal shutter LQS, relay lens REL, the first polarizing beam splitter PBS2, the light passes the first sensor SL1, and the astigmatism is given, and light received by the first light detector PD1. After that, such an operation is repeated, and the recording operation of the information to the optical disk having the second protective substrate PL2 or the reproducing operation of the information recorded in the optical disk having the second protective substrate PL2 is completed.

As the objective lens OBJ1 in the present embodiment, when the recording or reproducing of the information is conducted on the first optical information recording medium having the first protective substrate thickness (t1), it is preferable that the objective lens in which the spherical aberration is corrected under the condition that the almost parallel or slightly converging light flux is incident on the objective lens, is used.

In such a case, as detailed in the present embodiment, when the recording or reproducing of the information is conducted on the first optical information recording medium having the second protective substrate thickness (t2), at least one lens group of the relay lens group is moved and is made so that the divergent light flux is incident on the objective lens, and when the using magnification of the objective lens is changed, the spherical aberration generated in the optical disk having the second protective substrate thickness can be corrected. In that case, when it is made so as not to be less than the lower limit value of the above-described conditional expression (1), the aberration generated when relay lens group is de-centered, is decreased, and a good spot can be generated on the information recording surface, hereby, at least one signal of a good recording signal and a reproducing signal can be obtained. Further, generally, the movement amount of the actuator and the de-centering accuracy are proportional, and when the upper limit value is made not to be over, it becomes possible to prevent that the movement amount of the movable lens group in the relay lens group becomes too large, hereby, the load charged over the actuator is decreased, and the de-centering amount following the movement is decreased, and the size-reduction of the apparatus can be intended.

Furthermore., when the above-described conditional expressions (1) and (5) are satisfied, because, the entrance pupil diameter (in FIG. 11, the entrance pupil diameter, for example, to the second lens group L1) in which the rely lens group and the objective lens are compounded to obtain the necessary numerical aperture NA1 (numerical aperture to the first optical information recording medium), NA2 (numerical aperture to the second optical information recording medium) of the objective lens, necessary when the recording or reproducing of the optical disk having the first and the second protective substrate thickness is conducted, is made almost the same, not depending on the difference between the numerical apertures of the first optical information recording medium and the second optical information recording medium, the light flux which is projected from the semiconductor laser and collimated by the collimator can be introduced on the information recording surface without loss, hereby, the optical pick-up optical system whose using efficiency of the light is high, can be obtained. Hereupon, “almost the same” herein means that, when the entrance pupil diameter at the time of NA1 is r1, and the entrance pupil diameter at the time of NA2 is r2, r2 is larger than 80% of r1, and smaller than 120%. More preferably, r2 is larger than 90% of r1, and smaller than 110%. Furthermore preferably, r2 is larger than 95% of r1, and smaller than 105%. Most preferably, r2 is equal to r1.

Further, in another saying, the above-described conditional expression (2), more preferably, the conditional expression (3) is satisfied. When this conditional expression (2) is satisfied, further preferably, when the conditional expression (3) is satisfied, in the same manner as above description, not depending on the difference of numerical aperture, the light flux projected from the semiconductor laser can be introduced on the information recording surface without loss, and the optical system for the first semiconductor laser whose using efficiency of the light is high, can be obtained.

Another Embodiment 2 of the Compatible Optical System

In the above mentioned embodiments, a movable optical member such as a relay lens movable in an optical axis direction is used. However, in the BD/HD compatible optical system, in place of the structure to use the movable optical member, a stationary type compatible optical system can be structured by a polarizing optical system 103 to change a polarizing direction of a light flux 102 emitted from the first semiconductor laser LD1 (wavelength λ1=380 nm-450 nm), a diffractive optical element 107 made of a doubly refracting material and capable of converging a light flux onto different surfaces in accordance with the polarizing direction 104, 105 of the light flux, and an objective optical element 106 and 108. With regard to the doubly refracting material, an example is disclosed in Official gazette of Paten Publication (TOKUHYOU) 2004-516594.

### Embodiment of Objective Lens

Next, an embodiment of the first objective lens OBJ1, which can be applied to the optical pickup described above. With regard to the second objective lens OBJ2, since it is possible to use the objective lens being a conventional DVD/CD compatible objective lens or an objective lens dedicated for CD, the detailed explanation will not be described here.

According to the embodiments described above, since the light flux having the shortest wavelength λ1 are arranged to be focused on each information recording surface of different kinds of optical discs being BD and HD, it is possible to efficiently use the light flux emitted from the first semiconductor laser LD1. In the embodiment, the optical path from the semiconductor lasers LD1-LD3 to the first objective lens OBJ1 and the second objective lens OBJ2 is arranged so that the distance between the converged light spots formed by the first objective lens OBJ1 and the second objective lens OBJ2 in a surface orthogonal to the optical axes of these objective lenses is at least more than the radius of the first objective lens OBJ1 or the second objective lens OBJ2. Accordingly, it is not necessary to switch the first objective lens OBJ1 and the second objective lens OBJ2 to correspond to the optical disc onto or from which information is recorded and or reproduced. Also, it is not necessary to provide a moving mechanism for switching those objective lenses. Consequently, it becomes possible to provide an optical pickup apparatus having a simple and compact structure.

It is also possible to use three lasers in one package, which includes three lasers having three different kinds of wavelengths can be used regardless of the embodiments of the present invention.

### EXAMPLE 1

Example 1 described below is a preferable example of an optical pickup apparatus shown in the second embodiment of FIG. 9 (compatible only between BD and HD) or in the third embodiment of FIG. 10. The lens data of the embodiment 1 will be shown in table 1. In the following embodiments and tables, the expression of the number of power (exponential) to 10 for example, (2.5×10-3) will be expressed as (2.5E-3).

TABLE 1
[Example 1]
[Optical specifications]

BD: NA_{BD} = 0.85, λ₁ = 405 nm, d4_{BD} = 0.5312, d5_{BD} = 0.1,
The diameter of a diaphragm_{BD} = φ3.0000
HD: NA_{HD} = 0.65, λ₁ = 405 nm, d4_{HD} = 0.3044, d5_{HD} = 0.6,
The diameter of a diaphragm_{HD} = φ2.2900

[Paraxial data]

| Surface | | | | | |
|---|---|---|---|---|---|
| number | r(mm) | d(mm) | N₄₀₅ | ν_{d} | Remarks |
| OBJ | | Indefinite | | | light source |
| STO | | 0.5000 | | | diaphragm |
| 1 | Indefinite | 1.0000 | 1.5247 | 56.5 | aberration |
| 2 | Indefinite | 0.2000 | | | correction element |
| 3 | 1.2372 | 2.1400 | 1.6227 | 61.2 | objective lens |
| 4 | −3.3048 | d4 | | | |
| 5 | Indefinite | d5 | 1.6195 | 30.0 | protective layer |
| 6 | Indefinite | | | | |

[Aspherical surface]

| | 1st surface | 3rd surface | 4th surface |
|---|---|---|---|
| κ | 0.0000E+00 | −6.5735E−01 | −1.1212E+02 |
| A4 | 1.2695E−04 | 1.5546E−02 | 1.5169E−01 |
| A6 | −1.4826E−04 | −1.0395E−02 | −2.5481E−01 |
| A8 | 7.7116E−05 | 1.0347E−02 | 3.5667E−01 |
| A10 | −1.4320E−05 | −9.7395E−03 | −3.7802E−01 |
| A12 | 0.0000E+00 | 2.9457E−03 | 2.1856E−01 |
| A14 | 0.0000E+00 | 3.9500E−03 | −5.1014E−02 |
| A16 | 0.0000E+00 | −4.3906E−03 | 0.0000E+00 |
| A18 | 0.0000E+00 | 1.7571E−03 | 0.0000E+00 |
| A20 | 0.0000E+00 | −2.6284E−04 | 0.0000E+00 |

[Diffraction order, wavelength at manufacturing and optical
path related coefficient]

| | 1st surface |
|---|---|
| dor_{BD}/dor_{HD} | 0/1 |
| λB | 405 nm |
| B2 | 1.3000E−02 |
| B4 | −1.5052E−03 |
| B6 | 2.9776E−04 |
| B8 | −5.6129E−04 |
| B10 | 4.9431E−05 |

The optical surface of the objective optical system is formed by an axial symmetry aspherical surface defined by substituting the coefficient shown in Table 1 into the Formula 1.

$$X ( h ) = \frac{( {h}^{2} / R )}{1 + \sqrt{1 - ( 1 + κ ) {( h / R )}^{2}}} + {\sum }_{i = 0}^{θ} {A}_{2 i} {h}^{2 i} \qquad Formula 1$$

Where, X(h) is an axis in the optical axis direction (the traveling direction of light flux is defined as a positive direction), k is a constant of corn, A2i is an aspherical coefficient and h is a height from the optical axis.

The optical path length given to each wavelength of the light flux is calculated by substituting the coefficient shown in Table 1 into following optical path function defined by formula 2.

$$Φ ( h ) = {\sum }_{i = 0}^{5} {B}_{2 i} {h}^{2 i} \qquad Formula 2$$

Where, B₂i is a coefficient of the optical path on.

### EXAMPLE 2

Example 2 described below is a preferable embodiment of an optical pickup apparatus shown in the second embodiment of FIG. 9 (compatibility only between BD and HD) or in the third embodiment of FIG. 10. The lens data of the embodiment 2 e shown in table 2.

TABLE 2
[Example 2]
[Optical specifications]

BD: NA_{BD} = 0.85, λ₁ = 405 nm, d4_{BD} = 0.5312, d5_{BD} = 0.1,
The diameter of a diaphragm_{BD} = φ3.0000
HD: NA_{HD} = 0.65, λ₁ = 405 nm, d4_{HD} = 0.3007, d5_{HD} = 0.6,
The diameter of a diaphragm_{HD} = φ 2.2900

[Paraxial data]

| Surface | | | | | |
|---|---|---|---|---|---|
| number | r(mm) | d(mm) | N₄₀₅ | ν_{d} | Remarks |
| OBJ | | Indefinite | | | light source |
| STO | | 0.5000 | | | diaphragm |
| 1 | −41.1202 | 1.0000 | 1.5247 | 56.5 | aberration |
| 2 | 29.7426 | 0.2000 | | | correction element |
| 3 | 1.2372 | 2.1400 | 1.6227 | 61.2 | objective lens |
| 4 | −3.3048 | d4 | | | |
| 5 | Indefinite | d5 | 1.6195 | 30.0 | protective layer |
| 6 | Indefinite | | | | |

[Aspherical surface]

| | 1st surface | 2nd surface | 3rd surface | 4th surface |
|---|---|---|---|---|
| κ | 0.0000E+00 | 0.0000E+00 | −6.5735E−01 | −1.1212E+02 |
| A4 | 1.5455E−03 | 8.1819E−03 | 1.5546E−02 | 1.5169E−01 |
| A6 | −3.6622E−04 | −7.7567E−04 | −1.0395E−03 | −2.5481E−01 |
| A8 | 5.8573E−04 | 3.8134E−04 | 1.0347E−02 | 3.5667E−01 |
| A10 | −5.9042E−05 | 2.5412E−04 | −9.7395E−03 | −3.7802E−01 |
| A12 | 0.0000E+00 | 0.0000E+00 | 2.9457E−03 | 2.1856E−01 |
| A14 | 0.0000E+00 | 0.0000E+00 | 3.9500E−03 | −5.1014E−02 |
| A16 | 0.0000E+00 | 0.0000E+00 | −4.3906E−03 | 0.0000E+00 |
| A18 | 0.0000E+00 | 0.0000E+00 | 1.7571E−03 | 0.0000E+00 |
| A20 | 0.0000E+00 | 0.0000E+00 | −2.6284E−04 | 0.0000E+00 |

[Diffraction order, wavelength at manufacturing and optical
path related coefficient]

| | 1st surface | 2nd surface |
|---|---|---|
| dor_{BD}/dor_{HD} | −1/1 | 1/1 |
| λB | 405 nm | 405 nm |
| B2 | 6.2000E−03 | −9.0000E−03 |
| B4 | −7.6350E−04 | −4.3081E−03 |
| B6 | 1.1637E−04 | 3.9668E−04 |
| B8 | −2.6822E−04 | −1.9467E−04 |
| B10 | 2.3187E−05 | −1.3480E−04 |

### EXAMPLE 3

Example 3 described below is a preferable embodiment of an optical pickup apparatuses shown in the second embodiment of FIG. 9 (compatible only between BD and HD) or FIG. 10. The lens data of the embodiment 3 will be shown in table 3.

TABLE 3
[Example 3]
[Optical specifications]

BD: NA_{BD} = 0.85, λ₁ = 405 nm, d2_{BD} = 5.0000, d6_{BD} = 0.6623,
d7_{BD} = 0.1000, The diameter of a diaphragm_{BD} = φ3.8700
HD: NA_{BD} = 0.65, λ₁ = 405 nm, d2_{HD} = 0.6675, d6_{HD} = 0.5107,
d7_{BD}= 0.6000, The diameter of a diaphragm_{BD} = φ 2.9000

[Paraxial data]

| Surface | | | | |
|---|---|---|---|---|
| number | r(mm) | d(mm) | N₄₀₅ | Remarks |
| OBJ | | Indefinite | | light source |
| 1 | −3.38610 | 0.6000 | 1.57732 | expander optical system |
| 2 | Indefinite | d2 | | |
| 3 | Indefinite | 0.1000 | 1.58763 | |
| 4 | −7.23778 | 10.0000 | | |
| STO | Indefinite | 0.0000 | | diaphragm |
| 5 | 1.54277 | 2.6500 | 1.64109 | Objective les |
| 6 | −5.41817 | d6 | | |
| 7 | Indefinite | d7 | 1.62230 | protective layer |
| 8 | Indefinite | | | |

[Aspherical surface]

| | 1st surface | 4th surface | 5th surface | 6th surface |
|---|---|---|---|---|
| κ | −0.609419 | −0.587268 | −0.659380 | −143.519257 |
| A4 | 0.000000E+00 | 0.000000E+00 | 0.786619E−02 | 0.111452E+00 |
| A6 | 0.000000E+00 | 0.000000E+00 | 0.294838E−03 | −0.123960E+00 |
| A8 | 0.000000E+00 | 0.000000E+00 | 0.199862E−02 | 0.824228E−01 |
| A10 | 0.000000E+00 | 0.000000E+00 | −0.132577E−02 | −0.390617E−01 |
| A12 | 0.000000E+00 | 0.000000E+00 | 0.303312E−03 | 0.112155E−01 |
| A14 | 0.000000E+00 | 0.000000E+00 | 0.223605E−03 | −0.142572E−02 |
| A16 | 0.000000E+00 | 0.000000E+00 | −0.169675E−03 | 0.000000E+00 |
| A18 | 0.000000E+00 | 0.000000E+00 | 0.441281E−04 | 0.000000E+00 |
| A20 | 0.000000E+00 | 0.000000E+00 | −0.427982E−05 | 0.000000E+00 |

### EXAMPLE 4

Example 4 described below is a preferable embodiment of an optical pickup apparatus shown in the first embodiment of FIG. 4 or in the second embodiment of FIG. 9 (compatible between BD, HD and DVD). The lens data of the embodiment 4 will be shown in table 4.

TABLE 4
[Example 4]
[Optical specifications]

BD: NA_{BD} = 0.85, λ₁ = 405 nm, d4_{BD} = 0.5323, d5_{BD} = 0.1,
The diameter of a diaphragm_{BD} = φ3.0000
HD: NA_{HD} = 0.65, λ₁ = 405 nm, d4_{HD} = 0.2992, d5_{HD} = 0.6,
The diameter of a diaphragm_{HD} = φ2.2900
DVD: NA_{DVD} = 0.63, λ₁ = 655 nm, d4_{DVD} = 0.3146, d5_{DVD} = 0.6,
The diameter of a diaphragm_{HD} = φ 2.2900

[Paraxial data]

| Surface | | | | | |
|---|---|---|---|---|---|
| number | r(mm) | d₁(mm) | N₄₀₅ | N₆₅₅ | Remarks |
| OBJ | | Indefinite | | | light source |
| STO | | 0.5000 | | | diaphragm |
| 1 | 22.19290 | 1.0000 | 1.5247 | 1.5065 | aberration |
| 2 | 32.81901 | 0.2000 | | | correction element |
| 3 | 1.23720 | 2.1400 | 1.6227 | 1.6032 | objective lens |
| 4 | −3.30480 | d4 | | | |
| 5 | Indefinite | d5 | 1.6195 | 1.5772 | Protective |
| 6 | Indefinite | | | | layer |

[Aspherical surface]

| | 1st surface | 2nd surface | 3rd surface | 4th surface |
|---|---|---|---|---|
| κ | 0.0000E+00 | 0.0000E+00 | −6.5735E−01 | −1.1212E+02 |
| A4 | −2.9183E−03 | −7.7155E−03 | 1.5546E−02 | 1.5169E−01 |
| A6 | 2.8906E−04 | −5.1371E−03 | −1.0395E−03 | −2.5481E−01 |
| A8 | −9.6606E−04 | 3.0935E−03 | 1.0347E−02 | 3.5667E−01 |
| A10 | 8.3994E−05 | −1.3624E−03 | −9.7395E−03 | −3.7802E−01 |
| A12 | 0.0000E+00 | 0.0000E+00 | 2.9457E−03 | 2.1856E−01 |
| A14 | 0.0000E+00 | 0.0000E+00 | 3.9500E−03 | −5.1014E−02 |
| A16 | 0.0000E+00 | 0.0000E+00 | −4.3906E−03 | 0.0000E+00 |
| A18 | 0.0000E+00 | 0.0000E+00 | 1.7571E−03 | 0.0000E+00 |
| A20 | 0.0000E+00 | 0.0000E+00 | −2.6284E−04 | 0.0000E+00 |

[Diffraction order, wavelength at manufacturing and optical
path related coefficient]

| | 1st surface | 2nd surface |
|---|---|---|
| dor_{BD}/dor_{HD}/dor_{DVD} | 1/2/1 | 2/2/1 |
| λB | 405 nm | 405 nm |
| B2 | 1.2000E−02 | −4.0000E−03 |
| B4 | −1.5742E−03 | 2.0302E−03 |
| B6 | 2.2983E−04 | 1.3411E−03 |
| B8 | −5.4707E−04 | −8.0886E−04 |
| B10 | 5.2031E−05 | 3.5700E−04 |

### EXAMPLE 5

Example 5 described below is a preferable embodiment of an optical pickup apparatus shown in the first embodiment of FIG. 4 or in the second embodiment of FIG. 9 (compatible between BD, HD and DVD). The lens data of the embodiment 5 will be shown in table 5.

TABLE 5
[Example 5]
[Optical specifications]

BD: NA_{BD}= 0.85, λ₁ = 405 nm, d6_{BD} = 0.5312, d7_{BD} = 0.1,
The diameter of a diaphragm_{BD} = Φ3.0000
HD: NA_{HD} = 0.65, λ₁ = 405 nm, d6_{HD} = 0.2970, d7_{HD} = 0.6,
The diameter of a diaphragm_{HD} = Φ 2.2700
DVD: NA_{DVD} = 0.65, λ₁ = 655 nm, d6_{DVD} = 0.3306, d7_{DVD} = 0.6,
The diameter of a diaphragm_{HD} = Φ 2.3400

[Paraxial data]

| Surface | | | | | |
|---|---|---|---|---|---|
| number | r(mm) | d(mm) | N₄₀₅ | N₆₅₅ | Remarks |
| OBJ | | Indefinite | | | light source |
| STO | | 0.5000 | | | diaphragm |
| 1 | 22.2265 | 1.0000 | 1.5247 | 1.5065 | 1st aberration |
| 2 | 10.5780 | 0.3000 | | | correction element |
| 3 | Indefinite | 1.0000 | 1.5247 | 1.5065 | 2nd aberration |
| 4 | Indefinite | 0.1000 | | | correction element |
| 5 | 1.2372 | 2.1400 | 1.6227 | 1.6032 | objective lens |
| 6 | −3.3048 | d6 | | | |
| 7 | Indefinite | d7 | 1.6195 | 1.5772 | protective layer |
| 8 | Indefinite | | | | |

[Aspherical surface]

| | 1st surface | 2nd surface | 5th surface | 6th surface |
|---|---|---|---|---|
| κ | 0.000E+00 | −1.1484E−01 | −6.5735E−01 | −1.1212E+02 |
| A4 | −2.4573E−03 | −4.6776E−04 | 1.5546E−02 | 1.5169E−01 |
| A6 | −9.1874E−04 | 3.8693E−05 | −1.0395E−03 | −2.5181E−01 |
| A8 | −2.5858E−04 | −7.4545E−05 | 1.0347E−02 | 3.5667E−01 |
| A10 | −6.2955E−05 | 2.9339E−05 | −9.7395E−03 | −3.7802E−01 |
| A12 | 0.0000E+00 | 0.0000E+00 | 2.9457E−03 | 2.1856E−01 |
| A14 | 0.0000E+00 | 0.0000E+00 | 3.9500E−03 | −5.1014E−02 |
| A16 | 0.0000E+00 | 0.0000E+00 | −4.3906E−03 | 0.0000E+00 |
| A18 | 0.0000E+00 | 0.0000E+00 | 1.7571E−03 | 0.0000E+00 |
| A20 | 0.0000E+00 | 0.0000E+00 | −2.6284E−04 | 0.0000E+00 |

[Diffraction order, wavelength at manufacturing and optical
path related coefficient]

| | 1st surface | 2nd surface | 3rd surface |
|---|---|---|---|
| dor_{BD}/dor_{HD}/dor_{DVD} | 1/2/1 | 2/2/1 | 0/0/1 |
| λB | 405 nm | 405 nm | 655 nm |
| B2 | 1.2000E−02 | −1.2500E−02 | 1.0000E−04 |
| B4 | −1.3486E−03 | 8.6475E−05 | −9.8590E−04 |
| B6 | −3.8137E−04 | −1.1517E−05 | 7.4516E−04 |
| B8 | −1.8689E−04 | 2.0661E−05 | −5.5261E−04 |
| B10 | −2.3160E−05 | −8.2219E−06 | 9.7725E−05 |

### EXAMPLE 6

Example 6 described below is a preferable embodiment of an optical pickup apparatus shown in the first embodiment of FIG. 4 or in the second embodiment of FIG. 9 (compatible between BD, HD and DVD). The lens data of the embodiment 6 will be shown in table 6.

TABLE 6
[Example 6]
[Optical specifications]

BD: NA_{BD} = 0.85, λ₁ = 405 nm, d6_{BD} = 0.5000, d6_{BD} = 0.6623
d7_{BD} = 0.1000, The diameter of a diaphragm_{BD} = Φ 3.8700
HD: NA_{HD} = 0.67, λ₁ = 405 nm, d2_{HD} = 0.56000, d6_{HD} = 0.5107,
d7_{HD} = 0.6000, The diameter of a diaphragm_{HD} = Φ2.9000
DVD: NA_{DVD} = 0.65, λ₁ = 655 nm, d2_{DVD} = 5.21000, d6_{DVD} = 0.4603,
d7_{DVD} = 0.6000, The diameter of a diaphragm_{HD} = Φ 2.9400

[Paraxial data]

| Surface | | | | | |
|---|---|---|---|---|---|
| number | r(mm) | d(mm) | N₄₀₅ | N₆₅₅ | Remarks |
| OBJ | | Indefinite | | | light source |
| 1 | −3.38610 | 0.6000 | 1.57732 | 1.55697 | expander |
| 2 | Indefinite | d2 | | | optical unit |
| 3 | Indefinite | 0.1000 | 1.58763 | 1.56692 | |
| 4 | −7.23778 | 10.0000 | | | |
| STO | Indefinite | 0.0000 | | | diaphragm |
| 5 | Indefinite | 1.0000 | 1.57732 | 1.55697 | aberration |
| 6 | Indefinite | 0.2000 | | | correction unit |
| 7 | 1.54277 | 2.6500 | 1.64109 | 1.61978 | objective lens |
| 8 | −5.41817 | d6 | | | |
| 9 | Indefinite | d7 | 1.62230 | 1.57995 | protective |
| 10 | Indefinite | | | | layer |

[Aspherical surface]

| | 1st surface | 4th surface | 7th surface | 8th surface |
|---|---|---|---|---|
| κ | −0.609419 | −0.587268 | −0.659380 | −143.519257 |
| A4 | 0.0000E+00 | 0.0000E+00 | 0.786619E−02 | 0.111452E+00 |
| AX6 | 0.0000E+00 | 0.0000E+00 | 0.294838E−03 | −0.123960E+00 |
| A8 | 0.0000E+00 | 0.0000E+00 | 0.199862E−02 | 0.824228E−01 |
| A10 | 0.0000E+00 | 0.0000E+00 | −0.132577E−02 | −0.390617E−01 |
| A12 | 0.0000E+00 | 0.0000E+00 | 0.303312E−03 | 0.112155E−01 |
| A14 | 0.0000E+00 | 0.0000E+00 | 0.223605E−03 | −0.142572E−02 |
| A16 | 0.0000E+00 | 0.0000E+00 | −0.169675E−03 | 0.0000E+00 |
| A18 | 0.0000E+00 | 0.0000E+00 | 0.441281E−04 | 0.0000E+00 |
| A20 | 0.0000E+00 | 0.0000E+00 | −0.427982E−05 | 0.0000E+00 |

[Diffraction order, wavelength at manufacturing and optical
path related coefficient]

| | 5th surface |
|---|---|
| dor_{BD}/dor_{HD}/dor_{DVD} | 0/0/1 |
| λB | 655 nm |
| B2 | 6.0000E−03 |
| B4 | −6.3516E−04 |
| B6 | −1.4109E−04 |
| B8 | −3.4877E−07 |
| B10 | −8.1896E−06 |

### EXAMPLE 7

Example 7 is appropriate for the optical pick-up apparatus in which the compatible optical system for the first semiconductor laser in the third embodiment of FIG. 10 is replaced with the another compatible optical system shown in FIG. 11, and hereinafter, the optical system part (optical system for the first semiconductor laser) shown in FIG. 11 will be described.

The optical disk (BD) having the first-class protective substrate PL1 is set to the wavelength λ₁=405 nm, protective substrate thickness t₁=0.1 mm, the first numerical aperture NA₁=0.85, and the optical disk (HD) having the second-class protective substrate PL2 is set to the wavelength λ₁=405 nm, protective substrate thickness t₂=0.6 mm, the second numerical aperture, NA₂=0.65, and the focal distance f of the first objective lens OBJ1=2.2 mm

Accordingly, the value of NA₁·TF₁/(NA₂·TF₂) is 1.0, and satisfies the conditional expression (2), and satisfies also 0.95≦NA₁·TF₁/(NA₂·TF₂)≦1.05 of the conditional expression (3).

Further, all of the lenses composing the relay lens group REL are formed of plastic of poly-olefin series, and the water absorption coefficient of the plastic of this poly-olefin series is about 0%.

The zoom lens function of relay lens group REL in the present example, has 2-group composition composed of the first lens group having the negative refractive power and the second lens group having the positive refractive power.

The data of each lens in the present example, and aspheric surface data are respectively shown below in the following Table 7 and Table 8, and the value of dn in the optical disk having the first-class protective substrate PL1 and the second-class protective substrate PL2 and the value of stop in Table 7, are shown in Table 9.

TABLE 7
(Paraxial data)

| Surface No. | r (mm) | d (mm) | n(405) | nd |
|---|---|---|---|---|
| OBJ | | ∞ | | |
| 1 | −6.860 | 0.800 | 1.54111 | 1.52510 |
| 2 | 8.827 | d2 | | |
| 3 | −13.114 | 1.200 | 1.54111 | 1.52510 |
| 4 | −5.041 | 7.000 | | |
| 5 | 1.543 | 2.650 | 1.64109 | 1.62299 |
| (stop) | | | | |
| 6 | −5.418 | d6 | | |
| 7 | ∞ | d7 | 1.62230 | 1.58546 |
| 8 | ∞ | | | |

Herein, “OBJ” in Table shows the object position, and because the light projected from the first semiconductor laser LD1 is collimated into the parallel light by the collimator lens CL, the object is at the infinite far position. Further, the signs r, d, n(405), nd in Table are respectively show the radius of curvature, surface interval, refractive index in the wavelength 405 nm, and refractive index in d-line (587 nm). Further, on the surface in which letters of “stop” is written in the “surface No.”, the numerical aperture limit member such as the liquid crystal shutter is provided on the surface of the first objective lens OBJ1.

TABLE 8
(Aspheric surface coefficient)

| | The 1st | The 4th | The 5th | The 6th |
|---|---|---|---|---|
| | surface | surface | surface | surface |
| κ | 0.00000 | 0.00000 | −0.65938 | −143.51926 |
| A4 | 1.5145E−03 | 4.2449E−04 | 7.8662E−03 | 1.1145E−01 |
| A6 | −1.6848E−03 | 2.3289E−05 | 2.9484E−04 | −1.2396E−01 |
| A8 | −1.7244E−04 | −3.0030E−05 | 1.9986E−03 | 8.2423E−02 |
| A10 | 1.8911E−04 | 5.1748E−06 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

TABLE 9

| | d(mm) |
|---|---|
| d₂(the first-class) | 5.898 |
| d₂(the second-class) | 0.400 |
| d₆(the first-class) | 0.662 |
| d₆(the second-class) | 0.527 |
| d₇(the first-class) | 0.100 = t₁ |
| d₇(the second-class) | 0.600 = t₂ |
| Stop (the first-class) | 3.848 |
| Stop (the second-class) | 3.236 |

As the result of that, a value of (NA₁δ)/(t₂−t₁) is 9.4, and satisfies 7.5≦(NA₁δ)/(t₂−t₁)≦22 in the conditional expression (5).

Furthermore, a value of p₁/p₂ is −2.05, and satisfies −3.5≦p₁/p₂≦−1.8 in the conditional expression (1).

What is claimed is:

1. An optical pickup apparatus for reproducing and/or recording information from/onto a first optical information recording medium including a protective layer having a thickness of ti by using a light flux having wavelength of λ1, for reproducing and/or recording information from/onto a second optical information recording medium including a protective layer having a thickness of t2 (t2>t1) by using a light flux having wavelength of λ1, and for reproducing and/or recording information from/onto at least one of a third optical information recording medium including a protective layer having a thickness of t3 (t3=t2) by using a light flux having wavelength of λ2 and a fourth optical information recording medium including a protective layer having a thickness of t4 (t4>t3) by using a light flux having wavelength of λ3 (λ3≧λ2), the optical pickup apparatus comprising:
a first light source for emitting a light flux having wavelength of λ1;
at least one of a second light source for emitting light flux having wavelength of λ2 and a third light source for emitting light flux having wavelength of λ3; and
a light converging optical system including
a first objective optical element for forming a converged light spot when reproducing and/or recording information from or onto at least the first optical information recording medium and the second optical information recording medium, and
a second objective optical element for forming a converged light spot when reproducing and or recording information from or onto at least one of the third optical information recording medium and the fourth optical information recording medium,
wherein an optical path of a light flux entering to the first objective optical element when using the first objective optical element and an optical path of a light flux entering to the second objective optical element when using the second objective optical element are arranged to be different so that a position of an incident light flux entering into the first objective optical element when using the first objective lens and a position of an incident light flux entering into the second objective optical element when using the second objective optical element are different in an orthogonal direction to an optical axis.

2. The optical pickup apparatus of claim 1, wherein the first objective optical element is used for forming a converged light spot when reproducing and or recording information from or onto the third optical information recording medium and the second objective optical element is used for forming a converged light spot when reproducing and or recording information from or onto the fourth optical information recording medium.

3. The optical pickup apparatus of claim 1, wherein the second objective optical element is used for forming a converged light spot when reproducing and or recording information from or onto the third optical information recording medium and the fourth optical information recording medium.

4. The optical pickup apparatus of claim 1, wherein, the second objective optical element is used for forming a converged light spot when reproducing and or recording information from or onto only the third optical information recording medium.

5. The optical pickup apparatus of claim 1, wherein the first objective optical element and the second objective optical element are placed in a radius direction of an optical information recording medium from or onto which information is reproduced and or recorded, when viewing from an optical axis direction.

6. The optical pickup apparatus of claim 1, wherein the first objective optical element and the second objective optical element are placed parallel to a tangential line direction of an optical information recording medium from or onto which information is reproduced and or recorded, when viewing from an optical axis direction.

7. The optical pickup apparatus of claim 6, wherein a line connected between optical axes of the first objective optical element and the second objective optical element is orthogonal to a line extending in a radius direction of an optical information recording medium from or onto which information is reproduced and or recorded on an optical axis of the first objective optical element or an optical axis of the second objective optical element, when viewing from an optical axis direction.

8. The optical pickup apparatus of claim 6, wherein a line connected between optical axes of the first objective optical element and the second objective optical element is arranged to orthogonal to a line extended in a radius direction of an optical information recording medium from or onto which information is reproduced and or recorded, in an area other than optical axes of the first objective optical element and the second objective optical element, when viewing from an optical axis direction.

9. The optical pickup apparatus of claim 6, wherein a line connected between optical axes of the first objective optical element and the second objective optical element is arranged to non-orthogonal to a line extended in a radius direction of an optical information recording medium from or onto which information is reproduced and or recorded, in an area other than optical axes of the first objective optical element and the second objective optical element, when viewing from an optical axis direction.

10. The optical pickup apparatus of claim 1, further comprising:
a relay lens group provided between the first light source and the first objective optical element and including a movable lens group movable in an optical axis, wherein a divergent angle of a light flux having the wavelength of λ1 and emitted through the relay lens group is changed by a movement of the movable lens group.

11. The optical pickup apparatus of claim 10, wherein when a divergent angle of a light flux having the wavelength λ1 and entering into the first objective optical element at the time of reproducing and/or recording information from/onto the first optical information recording medium is a first divergent angle and when a divergent angle of a light flux having the wavelength λ1 and entering into the first objective optical element at the time of reproducing and/or recording information from/onto the second optical information recording medium is a second divergent angle, the second divergent angle is larger than the first divergent angle.

12. The optical pickup apparatus of claim 10, wherein a light flux having the wavelength λ1 and the first divergent angle is a parallel light flux and a light flux having the wavelength λ1 and the second divergent angle is a divergent light flux.

13. The optical pickup apparatus of claim 1, further comprising:
a relay lens group provided between the first light source and the first objective optical element and including a movable lens group movable in an optical axis, wherein a magnification of the first objective optical element is changed by a movement of the movable lens group.

14. The optical pickup apparatus of claim 13, wherein the magnification of the first objective optical element at the time of reproducing and/or recording information from/onto the second optical information recording medium is larger than the magnification of the first objective optical element at the time of reproducing and/or recording information from/onto the first optical information recording medium.

15. The optical pickup apparatus of claim 1, further comprising:
a relay lens group provided between the first light source and the first objective optical element and including a movable lens group movable in an optical axis, wherein when NA₁ is a numerical aperture of the first objective optical element at the time of reproducing and/or recording information from/onto the first optical information recording medium, TF₁ is a combined focal length of the relay lens group and the first objective optical element the time of reproducing and/or recording information from/onto the first optical information recording medium, NA₂ is a numerical aperture of the first objective optical element at the time of reproducing and/or recording information from/onto the second optical information recording medium, and TF₂ is a combined focal length of the relay lens group and the first objective optical element the time of reproducing and/or recording information from/onto the'second optical information recording medium, the following formula is satisfied:
0.8≦NA₁·TF₁/(NA₂·TF₂)≦1.2

16. The optical pickup apparatus of claim 1, further comprising:
a polarizing element to change a polarizing direction of a light flux emitted from the first light source; and
a diffractive element made of a birefringence material to converge a light flux in accordance with the polarized direction of the light flux onto the first optical information recording medium or the second optical information recording medium.

17. The optical pickup apparatus of claim 1, wherein at least either the first objective optical element or the second objective optical element is configured by a single element.

18. The optical pickup apparatus of claim 17, wherein the single element is made from glass.

19. The optical pickup apparatus of claim 17, wherein the single element is made from plastic.

20. The optical pickup apparatus of claim 1, wherein at least either the first objective optical element or the second objective optical element is configured by a plurality of elements.

21. The optical pickup apparatus of claim 20, wherein the plurality of elements is make from glass.

22. The optical pickup apparatus of claim 20, wherein the plurality of elements is make from plastic.

23. The optical pickup apparatus of claim 20, wherein at least one element in the plurality of elements is made from glass and rest of the elements in the plurality of elements are make from plastic.

24. The optical pickup apparatus of claim 1, wherein at least an optical surface of either the first objective optical element or the second objective optical element includes a diffraction structure or a phase difference generation structure.

25. The optical pickup apparatus of claim 1, wherein the light converging optical system comprises a correction element for correcting spherical aberration caused by a difference between a thickness of a protective layer of the first optical information recording medium and a thickness of a protective layer of the second optical information recording medium.

26. The optical pickup apparatus of claim 1, wherein the correction element is arranged to move in an optical axis direction.

27. The optical pickup apparatus of claim 26, further comprises a driving device for moving the correction element in the optical axis direction, the driving device including an electro-mechanical conversion element, a driving member fixed onto one end of the electro-mechanical conversion element, a moving member connected to the correction element supported on the driving member so that the correction element freely moves and a driving circuit for inputting voltage to the electro-mechanical conversion element, wherein the moving member is relatively moved against the driving member by extension and contraction of the electro-mechanical conversion element, the extension and contraction being generated corresponding to inputted voltage from the driving circuit.

28. The optical pickup apparatus of claim 26, further comprising a stepping; motor for moving the correction element in an optical axis direction.

29. The optical pickup apparatus of claim 1, wherein the first objective optical element comprises a diffraction structure for generating diffracted light flux having different plural orders at least against light flux having a wavelength of λ1 corresponding to an optical information recording medium from or onto which information is reproduced and or recorded.

30. The optical pickup apparatus of claim 29, wherein the diffracted light flux having the different plural orders includes either (n+1) order diffracted light flux or (n-1) order diffracted light flux when one of light beam has n order diffracted light flux, wherein “n” denotes an integer.

31. The optical pickup apparatus of claim 29., wherein the diffraction structure is placed within an area corresponding to an numerical aperture being equal to or less than an image-side numerical aperture of the objective optical element needed for reproducing and or recording information from or onto the second optical information recording medium by using the first light source.

32. The optical pickup apparatus of claim 26, wherein the correction element is a liquid crystal element.

33. The optical pickup apparatus of claim 1, wherein the first light source and the second light source are configured into a same light source unit.

34. The optical pickup apparatus of claim 1, wherein the second light source and the third light source are configured into a same light source unit.

35. The optical pickup apparatus of claim 1, wherein the first light source and the third light source are configured into a same light source unit.

36. The optical pickup apparatus of claim 1, wherein the light converging optical system includes a dichroic prism.

37. The optical pickup apparatus of claim 1, wherein the light converging optical system includes either a mirror or a prism.

38. The optical pickup apparatus of claim 1, wherein the first light source has light flux having wavelength λ1 being not less than 380 nm and not more than 450 nm, the second light source has light flux having wavelength λ2 being not less than 600 nm and not more than 700 nm and the third light source has light flux having wavelength λ3 being not less than 700 nm and not more than 800 nm.

39. The optical pickup apparatus of claim 1, wherein the first optical information recording medium has a protective layer having a thickness of t1 being within 0.1±0.93 mm, the second and the third optical information recording media respectively has a protective layer having thickness of t2 or t3 being within 0.6±0.1 mm and the fourth optical information recording medium has a protective layer having a thickness of t1 being within 1.2±0.1 mm.

40. The optical pickup apparatus of claim 1, wherein an objective optical element used to reproduce and or record information from or onto the first optical information recording medium has a numerical aperture NA1 falling within the range of 0.8-0.9, an objective optical element used to reproduce and or record information from or onto the second optical information recording medium has numerical aperture NA2 falling within the range of 0.6-0.7, an objective optical element applied to reproduce and or record information from or onto the third optical information recording medium has numerical aperture NA3 falling within the range of 0.58-0.68 and an objective optical element applied to reproduce and or record information from or onto the fourth optical information recording medium has numerical aperture NA4 falling within the range of 0.45-0.55.
